(19) United States
(12) Patent Application Publication
(10) Pub. No.: US 2023/0289745 A1
(43) Pub. Date: Sep. 14, 2023

(54) Systems for Actively Monitoring Lift Devices and Maintaining Lift Devices, and Related Methods

(71) Applicant: Xicore Inc., Mississauga (CA)

(72) Inventors: Ray ELEID, Mississauga (CA); Fransky HALIM, Mississauga (CA)

(73) Assignee: Xicore Inc., Mississauga, ON (CA)

(21) Appl. No.: 18/319,966

(22) Filed: May 18, 2023

Related U.S. Application Data
(63) Continuation-in-part of application No. 17/823,837, filed on Aug. 31, 2022.
Application No. 17/823,837 is a continuation of application No. 15/880,082, filed on Jan. 25, 2018, now abandoned.
Application No. 15/880,082 is a continuation-in-part of application No. 15/662,227, filed on Jul. 27, 2017, now Pat. No. 11,097,923.
Application No. 15/662,227 is a continuation-in-part of application No. 15/049,336, filed on Feb. 22, 2016, now Pat. No. 9,767,441.
Application No. 15/049,336 is a continuation-in-part of application No. 14/514,260, filed on Oct. 14, 2014, now Pat. No. 9,747,585.

(51) Int. Cl. G06Q 10/20; G06Q 10/0631; B66B 5/00; G06Q 10/109; B66B 25/00

(52) U.S. Cl. CPC G06Q 10/20; G06Q 10/06311; B66B 5/0087; G06Q 10/109; B66B 5/0025; B66B 25/006; B66B 27/00

(57) ABSTRACT

Methods and systems are provided for monitoring and controlling remote lift devices, such as elevators or escalators, by using machine vision or similar technologies to correlate real-life events with code events data from lift device controllers. Once there is a mapping between code events data with real-life life device events, the this mapping can be used to remotely monitor and control remote lift devices that use the same code events data software. The remote monitoring and control of remote lift devices can be combined with sensors on the lift devices using computer vision or similar technologies. Continuous monitoring of code events data with real-life events can be used to further refine the mapping, or to update the mapping if the software used in the elevator controllers changes.

### CROSS-REFERENCE TO RELATED APPLICATIONS

This application is a continuation-in-part of U.S. patent application Ser. No. 17/823,837, filed on Aug. 31, 2022 and titled “Devices and Systems For Actively Monitoring Lift Devices and Maintaining Lift Devices, and Related Methods” which is a continuation of U.S. patent application Ser. No. 15/880,082, filed on Jan. 25, 2018 and titled “System For Monitoring Elevators and Maintaining Elevators”, which is a continuation-in-part of U.S. patent application Ser. No. 15/662,227, filed on Jul. 27, 2017 and titled “Devices and Systems For Actively Monitoring Lift Devices and Maintaining Lift Devices, and Related Methods”, which is a continuation-in-part of U.S. patent application Ser. No. 15/049,336, filed on Feb. 22, 2016 and titled “System For Monitoring Elevators and Maintaining Elevators”, which is a continuation-in-part of U.S. patent application Ser. No. 14/514,260, filed on Oct. 14, 2014 and titled “Method of Retrieving and Uniformalizing Elevator Maintenance and Callback Data and Code Events”.

### TECHNICAL FIELD

The one or more inventions generally relate to monitoring lift devices and maintaining the maintenance of the lift devices, such as elevators and escalators.

### BACKGROUND

Often, facility owners have multiple service providers for escalators or elevators, or both, to maintain and repair their equipment, which is generally manufactured by various manufacturers. The service provider provides regular maintenance visits on a monthly, quarterly, or annual basis, as well as support in case of emergency (also called “callback”).

Callback is typically initiated by facility owners by using a telephone to call the service provider. Once initiated, the service provider enters the information obtained from the telephone discussion into its internal computer system and dispatches a technician to travel to the location of the faulty lift device. The information generated from the call and the dispatch becomes a part of the callback history, which is stored in a database. In some cases, facility owners are able to monitor and access the callback history, via an Internet connection, from the service provider's website. In many instances, a technician (i.e. a person) is sent to the elevator or escalator or moving sidewalk, herein interchangeably referred to as a “lift device”, to inspect or diagnose to lift device. The technician is physically present at the lift device and performs a series of tests to determine the operational performance or problems of the lift device.

### SUMMARY OF THE INVENTION

In accordance with the invention, there is provided a method for monitoring and managing lift devices, comprising: transmitting first code events data from a first lift device controller for a first lift device to a computing device; transmitting first sensor information from a first sensor on the first lift device to the computing device; converting the first sensor information to information about first device events; mapping correlations between the first device events with the first code events data, and storing these mappings; using these mappings to interpret second code events data from a second lift device controller for a second lift device as second device events, and using these second device events to monitor and control the second lift device. In one aspect of the invention, transmitting first code events data from a first lift device controller for a first lift device to a computing device includes transmitting timing information for the first code events data, and transmitting first sensor information from the first lift device to the computing device includes transmitting timing information for the first sensor information. In another aspect of the invention, the second lift device is the same as the first lift device. In another aspect of the invention, converting the first sensor information to information about first device events uses computer vision artificial intelligence. In still another aspect, the method further comprises: transmitting second sensor information from a second sensor on the first lift device to the computing device, and converting the first sensor information to information about first device events comprises converting the first sensor information and second sensor information to information about first device events. In another aspect, the first sensor is a camera. In another aspect, the method further comprises: updating the mappings by monitoring the first code events data and the first sensor information to see if the mappings from the first code event data correctly predict the device events, and if not correcting the mappings. In another aspect, using second device events to monitor and control the second lift device further comprises using second sensor information from the second lift device with the second device events to monitor and control the second lift device.

In accordance with the invention, there is provided a system for monitoring and managing lift devices, comprising: a first lift device controller for a first lift device configured to transmit first code events data from the first lift device controller to a computing device; a first sensor for the first left device configured to transmit first sensor information from the first sensor to the computing device; the computing device configured to convert the first sensor information to information about first device events; the computing device configured to map correlations between the first device events with the first code events data, and storing these mappings; and the computing device configured to use these mappings to interpret second code events data from a second lift device controller for a second lift device as second device events, and use these second device events to monitor and control the second lift device. In an aspect of this invention, the first lift device controller is further configured to transmit timing information for the first code events data, and first sensor is further configured to transmit timing information for the first sensor information. In another aspect, the second lift device is the same as the first lift device. In still another aspect, the computing device is configured to convert the first sensor information to information about first device events using computer vision artificial intelligence. In another aspect, the system further comprises: a second sensor for the first left device configured to transmit second sensor information from the second sensor to the computing device; and the computing device being configured to convert the first sensor information and the second sensor information to information about first device events. In another aspect, the computing device is further configured to update the mappings by monitoring the first code events data and the first sensor information to see if the mappings from the first code event data correctly predict the device events, and if not correcting the mappings. In another aspect, the computing device is configured to use second sensor information from the second lift device with the second device events to monitor and control the second lift device.

### BRIEF DESCRIPTION OF DRAWINGS

Embodiments will now be described by way of example only with reference to the appended drawings wherein:

FIG. 1 is an example system diagram of an elevator monitoring, maintenance, and management (EMMM) server in data communication with other computing devices or server machines, or both.

FIG. 2 is another example system diagram of the embodiment shown in FIG. 1.

FIG. 3 is an example of an EMMM application.

FIG. 4 is an example system diagram of a computing device that is in communication

with an elevator controller, or other conveyance device controller.

FIG. 5 is schematic of an elevator system that is controllable and actively monitored by a remote server, according to an example embodiment;

FIG. 6 is a schematic of an escalator system that is controllable and actively monitored by a remote server, according to an example embodiment;

FIG. 6 is an example system diagram of a field board.

FIG. 7 is an example system diagram showing relay components of a given field board, which is in electrical connection with an elevator controller.

FIGS. 8 to 11 are flow diagrams of example computer executable instructions for transmitting and receiving data via the web portal in relation to inspection and maintenance of an elevator, or other conveyance device.

FIG. 12 is a flow diagram of example computer executable instructions for a data retrieval process of data from a service provider server;

FIG. 13 is a flow diagram of example computer executable instructions for a data retrieval process of data from an elevator controller;

FIG. 14 is a flow diagram of example computer executable instructions for managing inspection orders;

FIGS. 15a, 15b and 15c show examples of datasets;

FIGS. 16a, 16b and 16c show examples of other datasets;

FIG. 17a shows an example of an XML string being transmitted;

FIG. 17b shows an example of data conversion;

FIG. 17c shows the data types of the Building Events Table;

FIG. 18 is a flow diagram of example computer executable instructions for adjusting executable instructions based on a critical time period;

FIG. 19 is a flow diagram of example computer executable instructions for responding to a technical failure of an elevator;

FIG. 20 is a flow diagram of example computer executable instructions for responding to a technical failure of an elevator, in consideration of a critical time period;

FIG. 21 is a flow diagram of example computer executable instructions for computing analytical algorithms to assess the technical failure;

FIG. 22 is a screenshot of an example graphical user interface (GUI) for showing information about elevator cars;

FIG. 23 is a screenshot of an example GUI showing call back details summarized for a facility owner responsible for multiple elevators or escalators, or both;

FIG. 24 is a screenshot of an example GUI showing critical hours and error codes;

FIG. 25 is a screenshot of an example GUI showing a report showing reformatted error codes associated with certain elevators or escalators, or both;

FIG. 26a shows an example of XML data from Vendors that is used to encapsulate the maintenance or callback history, or both, of an elevating device;

FIG. 26b shows an example of XML data from Vendors that is used to encapsulate the maintenance or callback history, or both, of an elevating device;

FIG. 26c shows an example of XML data from Vendors that is used to encapsulate the maintenance or callback history, or both, of an elevating device;

FIG. 27a shows an example of XML data from Vendors that is used to encapsulate the maintenance or callback history, or both, of an elevating device;

FIG. 27b shows an example of XML data from Vendors that is used to encapsulate the maintenance or callback history, or both, of an elevating device;

FIG. 28a shows an example of XML data from Vendors that is used to encapsulate the maintenance or callback history, or both, of an elevating device;

FIG. 28b shows an example of XML data from Vendors that is used to encapsulate the maintenance or callback history, or both, of an elevating device;

FIG. 29a shows an example of XML data from Vendors that is used to encapsulate the maintenance or callback history, or both, of an elevating device;

FIG. 29b shows an example of XML data from Vendors that is used to encapsulate the maintenance or callback history, or both, of an elevating device; and

FIG. 29c shows an example of XML data from Vendors that is used to encapsulate the maintenance or callback history, or both, of an elevating device.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

The term “elevator” is used herein in most examples. However, it will be appreciated that the principles and examples described herein with respect to elevators may also apply to other lift devices, such as escalators and moving sidewalk, also called moving walkways. The terms “conveyance devices” and “lift devices” are herein used to include elevators, escalator and moving walkways.

It is herein recognized that there are multiple difficulties in monitoring and maintaining lift devices.

It is also herein recognized that aspects of various lift devices can be monitored using different technologies to improve active maintenance and improved responsiveness.

It is also herein recognized that facility owners have a single building or multiple buildings, and in both cases they generally have multiple service providers. With the use of multiple service providers, facility owners are forced to manage multiple accounts in order to access the different web applications from each service provider. Additionally, the various service providers utilize different codes, data formats and presentations with respect to their data files. These codes and data formats are part of the service provider's or the manufacturer's computer system. Therefore, for the facility owner, it herein recognized that it is a mammoth task to collect and interpret the information from the various service providers, as there is no uniformalization of information storage among the various service providers. To further complicate this situation, service providers' computer files are not always available, and are typically accessible only on an on-demand basis.

It is also herein recognized that this lack of uniform data causes confusion for other entities, including authorities the ensure the safety of lift devices for the public, inspectors, facility owners, and the public. Moreover, this data is not effectively communicated amongst these different parties.

It is also herein recognized that, at the conclusion of a contract for services, facility owners may decide not to extend the contract with the service providers depending on multiple factors (e.g., quality of service, new service provider offers, etc.). When the contract between the facility owner and the service provider is terminated, the facility owner no longer has access to data and the computing systems of the service provider during the contract tenure. As a result, the callback and maintenance history is no longer available to the facility owner.

Since elevators and escalators have become computer controlled, they store elevator codes or events (e.g., information on the heat detectors or landing sensors) in the controller. It is herein recognized that, unfortunately, elevator/escalator code/event information is stored in a form that is proprietary to each manufacturer, and usage and maintenance data from different manufacturers cannot be compared.

Technicians who service elevators and escalators typically need to be at the physical location of the elevator controller to access the data from the controller. In particular, a technician is able to access various statistical data, events of use and the last service intervals from each elevator. From this data, technicians are able to facilitate servicing of the equipment.

It is herein recognized that, in some cases the facility owner is able to access the controller's event and code via a computer that is directly connected to the controller, either wired or wirelessly. The computer typically is at the same location as the controller. It is herein recognized that due to the direct connection between the controller and the facility owner's computer, the facility owner must be at the computer in order to open and view the event and code from the controller. As a result of the direct data connection between the controller and the computer, the facility owner has to manage multiple accounts and different computers located at different physical locations. Additionally, the facility owner has no backup in case of data failure/disaster recovery. Further, the facility owner may not have experience understanding the data from the controller. Furthermore, it is very unlikely that the facility owner would have the experience or knowledge to interpret the controller data to anticipate problems.

It is herein recognized that comparison of maintenance and usage data from various manufacturers is beneficial as it enables streamlining of maintenance procedures and comparison of elevators under different usage circumstances. It is also herein recognized that a method of uniformalizing has not been heretofore been used, which leads to the above noted technical difficulties. Therefore, it is herein recognized that it is desirable to retrieve and uniformalize elevator usage and maintenance data.

It is also herein recognized that current computing systems do not provide timely information to involved entities. Or, if information is constantly provided or accessible to involved entities, the urgency of the information is not indicated. Typically, computing systems for elevators do not automatically process currently received elevator controller data and historical data stored in a database to identify the technical issues of an elevator, and nor do typical computing systems executed computations to determine and output recommendations for addressing these technical issues.

The systems and methods described herein address one or more of the above various technical difficulties.

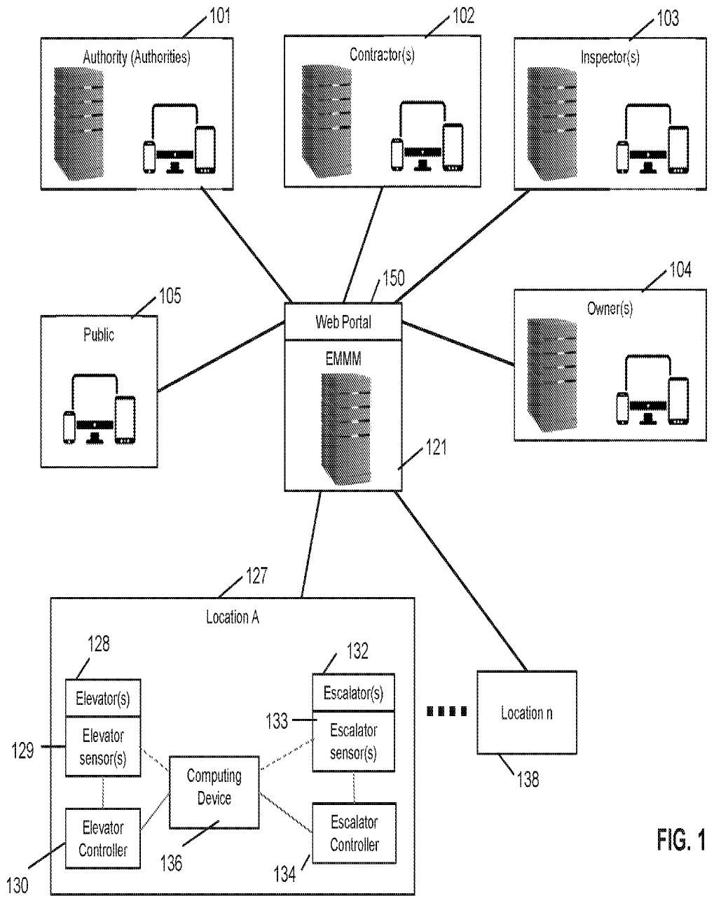

Turning to FIG. 1, a system is provided that distributes and processes information from various devices in relation to elevator maintenance, inspection and monitoring (including, for example, monitoring of near real-time data or real-time data).

A web portal 150 resides on, or is in communication with, one or more elevator monitoring, maintenance and management (EMMM) servers 121. The web portal 150 allows all conveyance device stakeholders (e.g. government, authority having jurisdiction (AHJ), conveyance owners, responsible party, consultants, contractors and certification entities and the public) to share relevant data with each other, and to process the data, in order to achieve a faster and more transparent outcome with respect to ensuring that the conveyance devices are in compliance with code and regulations.

The web portal 150 will have a data base information exchange that would facilitate the transfer of information between the parties to confirm if a given conveyance device is in compliance with the applicable code (e.g. elevator code, safety code, operating code, etc.).

The web portal 150 will have the ability to capture the data from one or more authorities 101 with respect to each conveyance device and then capture the data from the device contractor 102 with respect to work performed and certification entities (witnessing, inspecting, certification) and determine if the conveyance device is in compliance or not.

The web portal 150 facilitates the exchange of the information from all parties. In a further aspect, the EMMM server 121 automatically identifies delinquencies or issues and creates and sends notifications and electronic alerts regarding the same via the web portal 150.

The EMMM server 121 includes computing processes to collect data regarding sequences of events, and to create a priority or non-conformance list.

In particular, as per FIG. 1, one or more EMMM servers 121 are in data communication with one or more computing devices of one or more authorities 101, one or more computing devices of one or more contractors 102, one or more computing devices of one or more inspectors 103, and computing devices of one or more owners 104. In further examples aspect, the one or more EMMM servers 121 are in data communication with one or more computing devices from the public 105. For example, the one or more EMMM servers 121 are in data communication with these other computing devices 101, 102, 103, 104, 105 via the web portal 150 (e.g. over the Internet), or by other communication means (e.g. text message, telephone call, email, etc.), or a combination thereof.

The one or more computing devices 101, 102, 103, 104 include, for example, one or more server machines or one or more personal computing devices, or both. Non-limiting examples of personal computing devices include laptops, desktop computers, tablets, and mobile devices.

The one or more EMMM servers 121 are also in data communication with computing devices of different building locations (e.g. Location A, . . . , Location n, etc.) that have conveyance devices (e.g. elevators, escalators, moving walkways, etc.) located there.

In particular, at a given location (e.g. Location A 127), there are one or more elevators 128 which are controlled by an elevator controller 130. Each elevator system is equipped with one or more sensors 129. Examples of these sensors include: encoders, current sensors, hall-effect sensors, floor level sensors, door sensors, limit switches, temperature probes, temperature sensors, RADAR sensors, light sensors, and pressure sensors. It will be appreciated that other currently known and future-known sensors used in elevators or other lift devices are applicable. The sensors provide data to the elevator controller 130 or a computing device 136 located at Location A, or both.

In this example, one or more escalators 132 or moving walkways, or both, are being monitored with one or more sensors 133. The operation of the one or more escalator is controlled by an escalator controller 134. Data from the sensors 133 is transmitted to the escalator controller or the computing device 136, or both.

Within a given location, e.g. Location A, there may be multiple elevators and multiple elevator controllers that are in communication with a computing device 136. Consider a building that has both elevators and escalators.

Other locations (e.g. Location n 338) have similar systems.

The EMMM server 121 receives information from the computing device 136 about the elevators, escalators, etc. The EMMM server 121 also receives data from the one or more computing devices 101, 102, 103, 104, 105 from the different entities. The EMMM server processes the data and uses the processed data to automatically execute operations to coordinate actions amongst the one or more computing devices 101, 102, 103, 104, 105 from the different entities.

In particular, the authority computing device(s) 101 store thereon and output to the EMMM server 121 (via the web portal 150), a listing of conveyance device identification numbers. Furthermore, associated with each device identification number, the computing device(s) 101 store and output the building name, address, owner information, contractor, inspector (e.g. third party witnessing), device type, license expiration date, fees paid, CAT inspection date (e.g. all applicable CATs or mandated government/OEM testing), inspection reports, etc.

The contractor computing device(s) 102 store thereon and output to the EMMM server 121 (via the web portal 150) the following information for each conveyance device identification number: owner information, CAT inspection date (e.g. all applicable CATs), device type, maintenance activities, callback activities, inspection reports declaration, etc.

The inspector computing device(s) 103 store thereon and output to the EMMM server 121 (via the web portal 150), the following information for each conveyance device identification number: CAT inspection/witnessing reports (e.g. all applicable CATs), report status, report date, re-inspection requirement (e.g. yes/no), etc.

The owner computing device(s) 104 store thereon and output to the EMMM server 121 (via the web portal 150), the following information for each conveyance device identification number: responsible party information, payment options/instructions, inspection reports declaration, compliance status, etc.

The public computing device(s) 105 are able to access the web portal to search for and obtain information specific to a conveyance device, including compliance information, the last inspection date of the conveyance device, license expiration date, device type, and device identification number. The public can also use their computing device(s) 105 to submit complaints and other data (e.g. images, video, etc.) via the web portal 150 with respect to a given conveyance device. In an example aspect, the authority computing device 101 sets viewing parameters regarding what type of data is available to be displayed to the public, and what data is not to be displayed to the public, for conveyance devices in a certain geographical jurisdiction. It is appreciated that the EMMM server 150, for example, stores different viewing parameters for different geographical jurisdictions, as dictated by the relevant authorities.

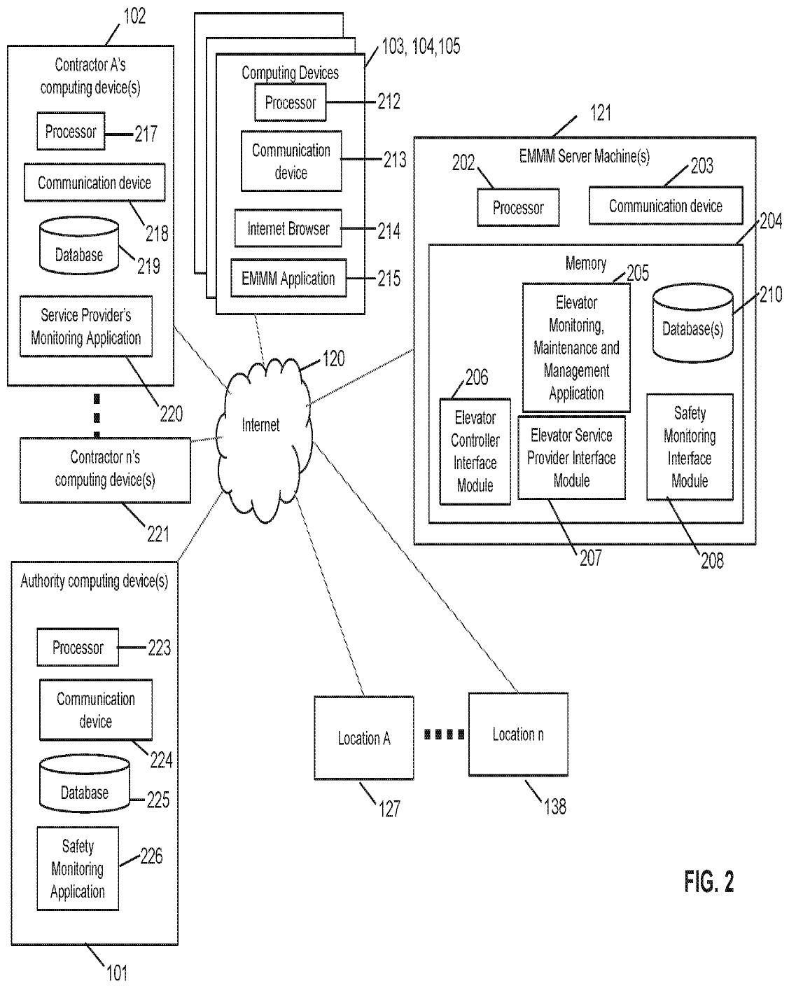

Turning to FIG. 2, another example embodiment of the system shown in FIG. 1 is provided, showing more detailed components. The example embodiment shows the data connectivity between various devices, including the elevators and the escalators. One or more EMMM server machines 121, computing devices 101, 102, 103, 104,105,221 and computing devices at different elevator locations 127, 138 are in data communication with each other over an Internet network 120. Other communication networks may be used, which may or may not include the Internet. For example, some communication networks include telecommunication networks, LAN networks, or wireless networks, or combinations thereof.

While each entity may utilize multiple server machines as part of their own server system, for brevity, the term “server” will hereon be used. Therefore, it is appreciated that the term “server” includes one or more server machines.

The EMMM server 121 obtains data from the computing devices 136 from one or more locations. The EMMM server also obtains data from the computing devices 101, 102, 103, 104, 105, 221, and also distributes data amongst these devices.

The EMMM server 121 includes a processor 202, a communication device 203 for receiving and transmitting data over the network 120, and memory 204. The memory includes one or more databases 210, an EMMM application 205, an elevator controller interface module 206 that interacts with a computing device 136 connected to an elevator controller 130, an elevator service provider interface module 207 that interacts with an elevator contractor server 102, and a safety monitoring interface module 208 that interacts with the authority computing device 101. In an example embodiment, these interface modules interact with corresponding application programming interfaces (APIs). In another example embodiment, these interface modules include APIs or are APIs. The databases 210 may also be herein referred to as a datastore.

The EMMM application 205 uses the elevator controller interface module 206 to communicate with the computing device 136 over the Internet network 120. It will be appreciated that the EMMM application 205 is able to obtain various types of electronic information from an elevator controller and the escalator controller, and is able to process such electronic information for monitoring, maintenance and management. In another example, the EMMM server is in data communication with an intermediary computing device (not shown), which is data communication with the elevator controller or the escalator controller, or both.

In an example embodiment, the EMMM application 205 is able to obtain MCP (Maintenance Control Program) tests or maintenance tasks, or both, about the elevator controller. In other words, the data obtained by the EMMM server includes various types of data, including for example: fault logs, error warnings, and maintenance tasks.

The authority computing device 101 includes data systems for facilitating processes of safety regulation. For example, a safety regulating body issues inspection reports and inspection orders. An inspection order is a task that must be executed to maintain safety of the device. The computing device 101 includes a processor 223, a communication device 224, a database 225 to index and manage the safety and maintenance information of the elevators, and a safety monitoring application 226 that tracks the inspections and the inspection orders.

The authority computing device 101 and the EMMM server 121 exchange data with each other to manage the inspections and the inspection orders.

The contractor's computing device 102 includes a processor 217, a communication device 218, a database 219 and a monitoring application 220. The contractor is also known as an elevator service provider. It is appreciated that there are different elevator service providers. The data stored and provided by the computing device 102 may be in a specific data format that is characteristic of the elevator service provider. In other words, another service provider n has stored on its computing device 221 elevator data that is in a different data format compared to the computing device 102. It will be appreciated that there may be multiple service providers (e.g. multiple contractors) and their respective servers are in data communication with the EMMM server 121.

A facility owner is considered a user and uses a computing device 104 to monitor and interact with the management of the elevators and other lift devices for which they are responsible. As noted above, the EMMM server 121 is able to accommodate multiple facility owners, each facility owner responsible for different types of lift devices that may be at different locations. Similarly, inspectors 103 have their own computing device 103 and people from the public have their own computing device 105. The facility owner, the inspector, and the people of the public, who are also called users, use a computing device that includes a processor 212, a communication device 213, and an Internet Browser 214. The graphical user interfaces (GUIs) provided by the EMMM server, for example, are web pages accessible via an Internet Browser, and in particular, a web portal 150.

In another example, one or more of these computing devices 101, 102, 103, 104, 105 include an EMMM application 215. This may be desirable, for example, where the computing device is a mobile device (e.g. tablet, smart phone, cellphone, etc.), but the application may also be used with non-mobile devices. The computing device includes both mobile and non-mobile devices.

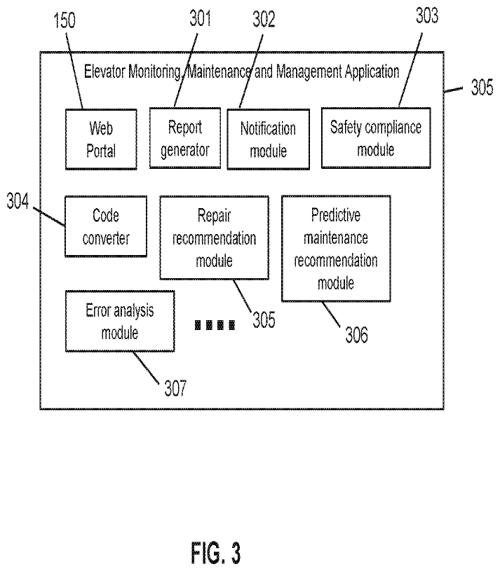

Turning to FIG. 3, example components of the EMMM application 305 are shown, including: a web portal 150, a report generator 301, a notification module 302, a safety compliance module 303, a code converter 304, a repair recommendation module 305, a predictive maintenance recommendation module 306, and an error analysis module 307. The web portal 150 generates GUIs, example aspects of which are shown in the figures. The report generator compiles data and automatically generates reports, which may be viewed via the GUI and also sent to other computing devices or servers, or both. The notification module generates and sends notifications to other computing devices or servers, or both. The safety compliance module tracks inspections and inspection orders, and automatically generates and sends reminders if inspection orders are not complete by a certain date. The code converter is manages and maps the databases of error codes that are specific to each of the service providers, and is able to convert these specific error codes in the service provider format to an EMMM format. The EMMM format is used throughout the system to provide uniformity and consistency to the users. The repair recommendation module includes computing processes to analyze the elevator data and recommend repairs to an elevator. The predictive maintenance module includes computing processes to analyze the elevator data and output maintenance actions and timelines in anticipation of elevator wear and elevator technical failure. The error analysis module includes computing processes to analyse the elevator data and output root problems of an elevator. The root problems may be technical. In another example, the root problems may also include human error (e.g. incorrect repairs, late maintenance, untimely response to elevator emergency, etc.).

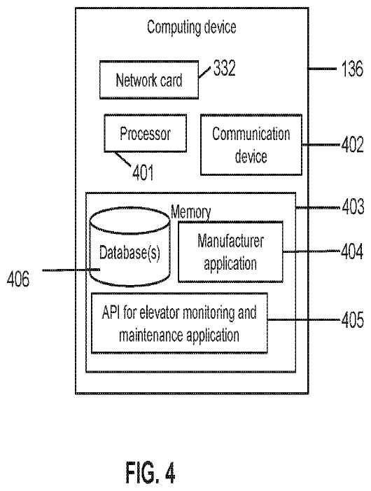

Turning to FIG. 4, an example of a computing device 136 is shown. It includes a processor 401, a communication device 402 for communicating over the network 120, and memory 403. The memory 403 includes, for example, a manufacturer application 404 for interpreting and logging the data, and an API for the EMMM application 405. Other locations (e.g. Location n 138) have similar systems. In particular, the manufacturer provides the application 404 which retrieves the information from their elevator controller. This application has a local database 406 where the information is being stored, such as in memory 335. This application is accessible to the client on site (e.g. Location A or some other location). The manufacturer provides an interface (e.g. API) to access the local database 406. In an example embodiment, the API 405 does not access the elevator controller. In an example embodiment, the API allows other software applications to communicate with the manufacturer application 404, which in turn, triggers the manufacturer application to communicate with the elevator controller. The EMMM application 205 accesses, or is provided with, the information on the local database 406 stored on the computing device 136. In other words, the information from the local database 406 is transmitted to the EMMM server 121. It will be appreciated that the EMMM application 205 is able to obtain various types of electronic information from an elevator controller, and is able to process such electronic information for monitoring, maintenance and management.

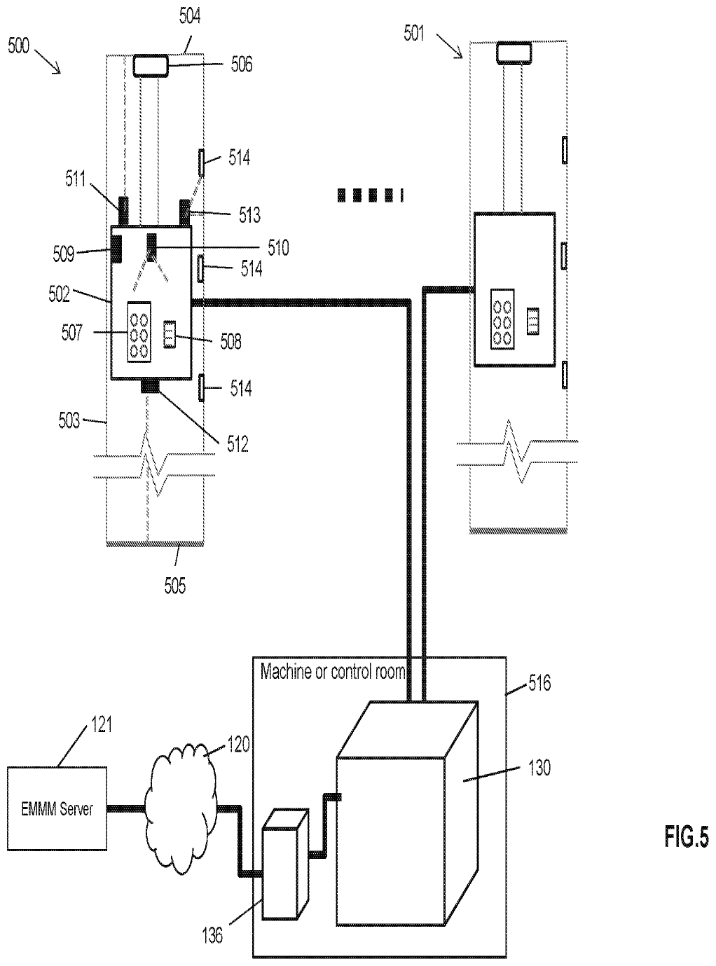

Turning to FIG. 5, an example embodiment of an elevator system is shown. For example, these elevators are the elevators at Location A 127 or Location n 138, although they are renumbered differently in FIG. 5. In particular, elevator systems 500 and 501 are shown, which are in electrical communication with an elevator controller 130 that is located within a machine or control room 516. The room 516 is typically located within the same building as the elevator systems 500 and 501.

The computing platform device 136 is in data communication with an elevator monitoring, maintenance and management (EMMM) server 121 over a wireless network connection 120, such as, but not limited to, the Internet. The EMMM server processes data in relation to various types of lift devices.

In an example embodiment, the EMMM server 121 is in data communication with other computing machines or devices, including one or more of: a server of an elevator service provider, a server of a safety monitoring party (e.g. the authority), and a computing device of a facility owner. The system collects elevator data, escalator data, or moving walkway data, or combinations thereof, and processes the same to, for example, index events, monitor the status of lift devices, identify technical problems, and provide notifications and reports. For example, a safety monitoring party is a technical and safety standards authority that enforces safety.

In an example embodiment, the elevator system 500 includes an elevator car 502 located within an elevator shaft 503. The elevator shaft includes a top structure (e.g. a ceiling) 504 that includes a pulley system 506 for the elevator car and a pit floor 505 located at the bottom of the shaft. In an example embodiment, the elevator shaft 503 includes brackets 514 or protruding structures located on the sidewall. For example, these brackets are placed at every floor, or are placed in greater number. Typically these brackets are evenly spaced.

The elevator car 502 also includes a button panel 507 and an audio communication system 508. For example, a user presses a button on the button panel 507 to indicate the floor that they wish to travel to. In another example, the audio communication system 508 allows a person that is not in the elevator car 502 (e.g. a security guard or a technician located in a different part of the building or external to the building) to make an audio announcement to the person in the elevator car. In other words, the communication system 508 is one-way. In another example, the audio communication system 108 provides two-way audio communication, such as by way of a telephone.

The elevator car 502 also includes various sensors. One or more of these sensors are, for example, retrofitted to an existing elevator car. Alternatively, or in addition, one or more of these sensors are already integrated to the elevator car. In an example embodiment, only one sensor is mounted to the elevator and, in another example embodiment, there are multiple sensors. In an example embodiment, one or more sensors are mounted within the elevator car. In addition or in the alternative, one or more sensors are mounted externally on to the elevator car.

In an example embodiment, a sensor 509 is mounted within the elevator car and it detects the presence of a person. For example, the sensor 509 is a camera that captures images (e.g. video or photos, or both) of the space within the elevator car. In an example embodiment, several cameras are mounted within the elevator car at different positions and these cameras may be of the same type, or may be of different types. The camera, for example, is an infrared camera. In another example, the camera is a typical camera that captures visible light. Other types of cameras can be used to detect a person. Currently known and future known image processing software may be used to process the image data from the camera or cameras and to automatically determine the presence of a person within the elevator car. The image processing software is also used to determine whether a person is moving or is staying still.

In another example, a sensor 510 is mounted within the elevator car and it emits or detects energy, or both, to detect whether a person is within the elevator car. For example, the sensor 510 is a RADAR sensor, or a light sensor, or a passive infrared sensor, or an ultrasonic sensor.

In another example, a sensor is mounted to the floor of the elevator car to detect the weight or pressure of a person standing or sitting in elevator car.

Other currently known and future known sensors for detecting a presence of a person that is within an elevator car are applicable to the principles described herein.

In another example, a sensor 511 is mounted externally to the elevator car, on its top, and detects the distance between the top of the elevator car and the top structure 504 of the elevator shaft. In this way, the distance information obtained by the sensor 511 can be used to compute the motion of the elevator car (e.g. whether it is moving up or down, and at what speed) and the position of the elevator car. The sensor 511 can be a RADAR sensor or another type of sensor that detects distance.

In another example, a sensor 512 is mounted externally to the elevator car, on its bottom, and detects the distance between the bottom of the elevator car and the pit floor 505 of the elevator shaft. In this way, the distance information obtained by the sensor 512 can be used to compute the motion of the elevator car (e.g. whether it is moving up or down, and at what speed) and the position of the elevator car. The sensor 512 can be a RADAR sensor or another type of sensor that detects distance.

In another example, a sensor 513 is mounted externally to the elevator car, and it is oriented to point at a side wall of the elevator shaft to detect the brackets 514. As the sensor 513 moves towards or away from a given bracket, it detects if the distance between the sensor 513 and the given bracket is getting smaller or larger. In this way, the sensor data can determine the direction of motion of the elevator. Furthermore, the change of distance over time is also used to determine the speed of the elevator. The sensor 513 can be a RADAR sensor or another type of sensor that detects distance.

For example, if the sensor 513 is pointing at an upward angle, and the computing device determines that the sensor is moving closer to given bracket, then the computing device determines that the elevator is moving upwards. It will be appreciated that different orientations and positions of the sensor 513 will vary the exact computations, for example, according the principles described herein.

In another example embodiment, an accelerometer is mounted to the elevator car and is used in combination or in alternative to the above noted sensors to detect the motion of the elevator car.

Other currently known and future known sensors for detecting the motion or position of an elevator car, or both, are applicable to the principles described herein.

The sensors mounted to the elevator car are in data communication with the elevator controller 130 or the computing device 136, or both. In this way, the data measured by the sensors can be processed by any one or more of the elevator controller, the field board, the computing platform device, and the EMMM server.

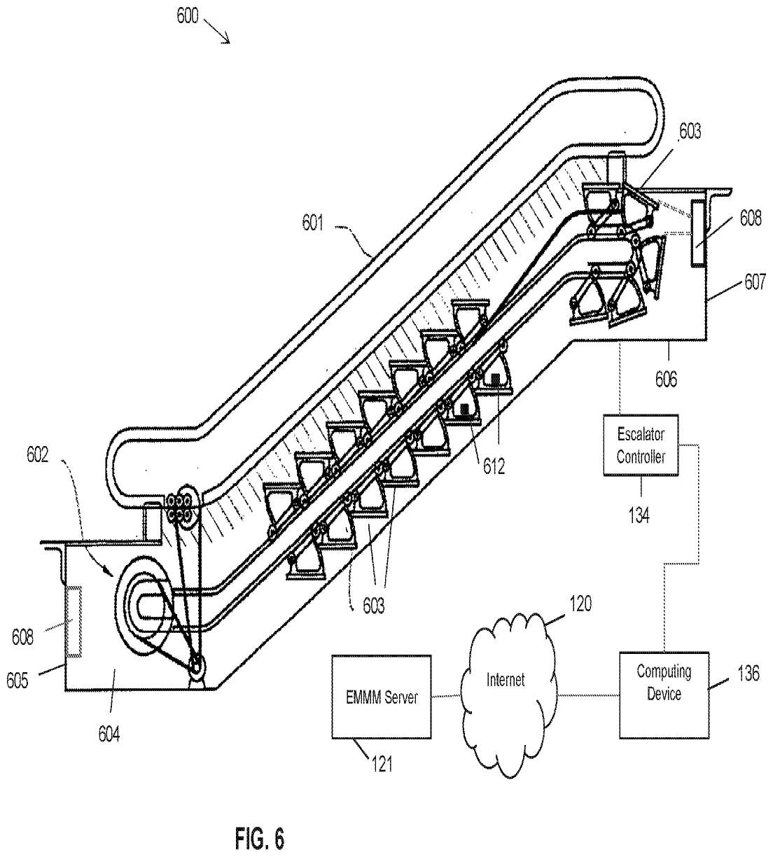

Turning to FIG. 6, an example embodiment of an escalator system is shown. For example, the escalator is an escalator at Location A 127 or Location n 138, although they are renumbered differently in FIG. 6. In particular, an escalator system 600 is shown. It includes, amongst other things, a handrail 601, a lower equipment pit 604 and an upper equipment pit 606. A motor 602 is mounted within an equipment pit and it moves a track of escalator steps 603. The escalator is in data communication (e.g. either wired or wirelessly) with an escalator controller 134. The escalator controller 134, for example, is mounted in a machine room or control room in the same building as the escalator. In an example embodiment, the field board 209 and the computing platform device 211 are added to an existing escalator controller, called a retrofit.

The computing device 136 is in data communication with the EMM server 121 over the wireless network connection 120, such as, but not limited to, the Internet.

One or more sensors 608 are mounted to a structure (e.g. structures 607, 605) in the equipment pits. The sensors detect movement of the escalator steps. For example, a sensor 608 mounted in the upper equipment pit 606 emits an energy beam at a fixed orientation. For example, the sensor 608 is a RADAR sensor or another type of sensor that emits an energy beam to detect distance (e.g. sound beam, light beam, microwave beam, etc.). As a given escalator step moves in a certain direction, the measured distance between the sensor and the surface of the given escalator step with either grow closer or grow farther over time. When the computing device detects that the distance is growing closer, then the computing device computes that the escalator is one of (i) moving up and (ii) moving down. When the computing device detects that the distance is growing further apart, then the computing device computes that the escalator is the other one of (i) moving up and (ii) moving down. Furthermore, the change of the distance over time is used to compute the speed at which escalator steps are moving.

It is appreciated that the specific relationship between the measured distance data from the sensor and the motion of the escalator steps will vary based on the positioning and orientation of the sensor.

In another example, one or more inertial measurement units (IMUs) 612 are mounted to one or more escalator steps to detect the change in motion of the escalator. For example, the one or more IMUs are used to detect the stopping or slow-down of the escalator, or the speed-up of the escalator. In an example embodiment, the IMU is an accelerometer. In an example embodiment, the IMU is mounted within the cavity of the escalator step.

These one or more sensors 608, 612 are in data communication with the escalator controller 610 or the computing device 136, or both. In this way, the data measured by the sensors can be processed by any one or more of the escalator controller, the computing device, and the EMMM server.

In an example embodiment, these one or more sensors 608, 612 are retrofitted to an existing escalator. These sensors provide independent verification of the movement of the escalator, compared to the existing control system of the escalator. This is helpful for monitoring potential or actual technical failures of the escalator.

It will be appreciated that the sensors and the devices described with respect to the escalator are also applicable to moving walkways, which also have a series of moving steps.

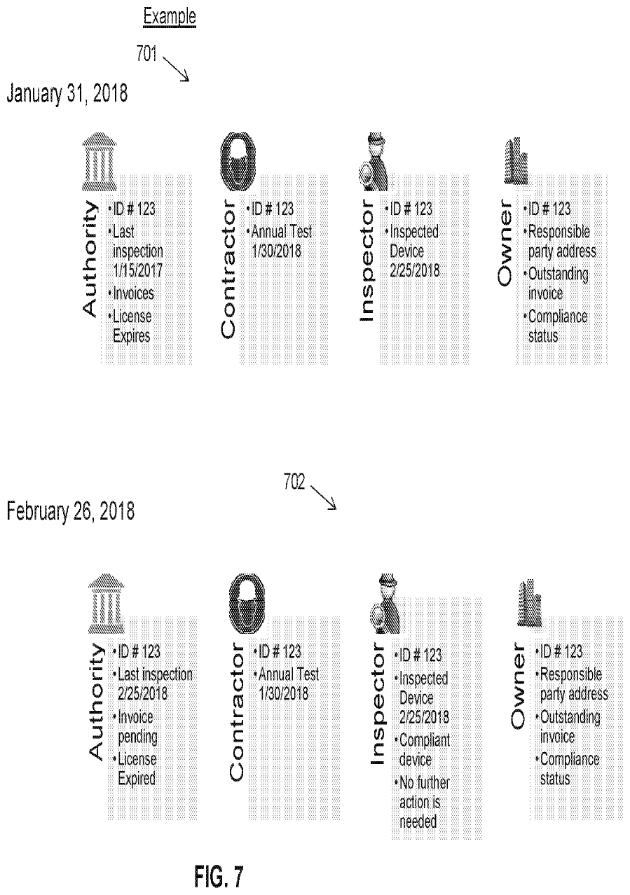

Turning to FIG. 7, an example embodiment of data at different computing devices associated with different entities is shown. In the initial stage 701, the Authority 101 shows that the last inspection was performed on Jan. 15, 2017. The system based on a requirement by the Authority 101 issues notices to the Contractor 102, Owner 104, Inspector 103, etc. that a given conveyance device is in need of an inspection. These notices are transmitted via the web portal or other electronic communication media (e.g. telephone call, email, text message, etc.). For example, this can occur 90 days in advance, or less. On or around Jan. 15, 2017, the system would verify if the inspection (inspection report, CAT test, etc., depending on the Authority) is posted or is completed. If the inspection is not done, the system would generate and transmit an electronic notice of default as required by the Authority. The system would then continuously run checks to determine if the report to be uploaded. Meantime, an escalation would follow as required by the Authority. This could be emails to senior management, fines, etc. All parties responsible for this conveyance device would be notified of the issues and delinquencies. In this example, the report is issued on Feb. 25, 2018 and the conveyance device is in compliance as of this date. An invoice is created and after certain conditions are met, the conveyance device becomes in compliance and a license is issued and transmitted over the network 120.

The system has the flexibility to allow the users to use its services or not. For example, if the Authority does not want to use the invoicing module in the web portal, the invoice can then be generated by the Authority and the system would capture that by posting that an invoice is issued and the invoice can be then posted on the system or noted as issued.

The web portal can also allow for processing of fees between all parties using secure payment authentication as well as receipt dispensing or can just post the invoice created by the Authority. If this is not desired, the system provides an indication that an invoice is pending.

So the previous example is now shown in portion 702 on Feb. 26, 2018.

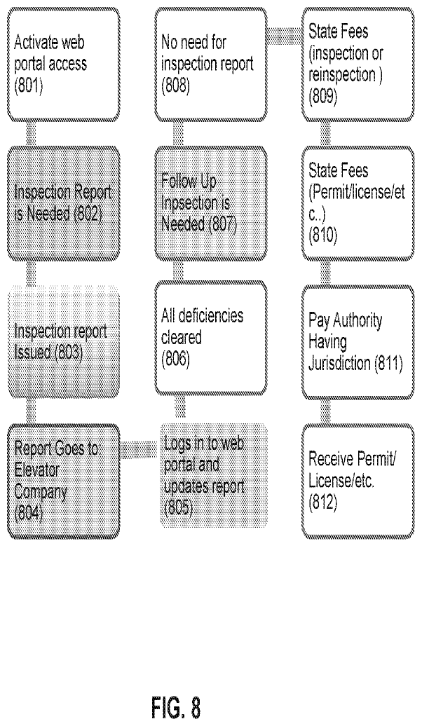

FIGS. 8 to 11 show example executable instructions to coordinate actions in relation to the conveyance devices.

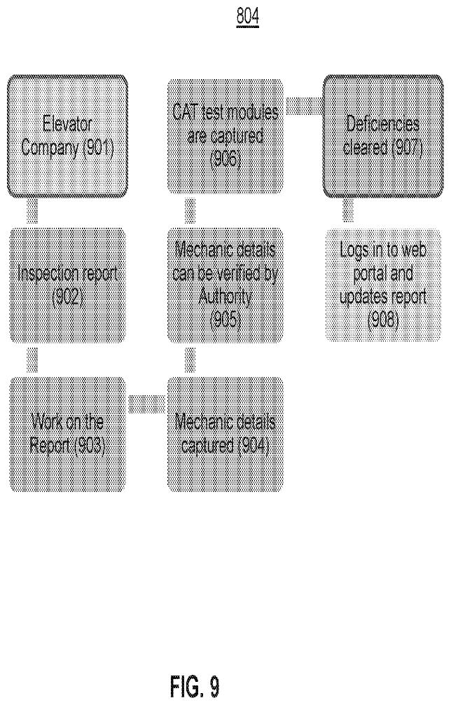

FIG. 8 shows an overall computing process, and FIGS. 9 to 11 show aspects of the computing process in FIG. 8.

Turning to FIG. 8, at block 801, the EMMM server 121 activates access to the web portal 150 for the entities and their computing devices 101, 102, 103, 104. For example, a login and password may be used to log into the EMMM server, or another type of data identifier used to authenticate a given entity. In some examples, a login and password is not required, as a given entity and an EMMM server are in contact with each other to automatically push information between each other. Access to the web portal may also be given to the public and their computing devices 105.

At block 802, the EMMM server receives a command from an entity that an inspection report is needed. For example, the contractor, or service provider, or elevator company, or authority sends a request to the web portal 150 to initiate generating an inspection report. Alternatively, the EMMM server detects certain parameters that initiate preparation of an inspection report. For example, a given elevator may have associated an electronic schedule that, on certain dates or time periods, initiate generating an inspection report. In another example, monitoring data or maintenance data that has been collected via sensors, an elevator controller, or by feedback from people (e.g. inspectors, maintenance works, the public), trigger a rule that initiates the need to generate an inspection report.

At block 803, the web portal 150 provides an electronic inspection report for entities to access.

In particular, the computing process of block 802, which leads to block 803, are shown in more detail in FIG. 11. In particular, the EMMM server detects that an inspection report is needed (block 1101) and, in response, the EMMM server generates and transmits a notification to a registered inspect (block 1102). The notification, for example, is sent via the web portal 150 or through other means (e.g. text message, phone call, email, etc.). The notification can be sent automatically, or it can be sent after being approved by another entity (e.g. authority, owner, or contractor, or a combination thereof). After the inspector receives the notification, the inspectors logs into the web portal (block 1103). The web portal presents a schedule GUI to allow the inspect to select an inspection date for the given conveyance device (block 1104). The GUI of the web portal, for example, provides a control to allow the inspector to complete the inspection alone, or with another inspector, or with a contractor (e.g. a maintenance technician who works for the contractor) (block 1105). If the another person or party is selected, then the EMMM server then notifies those other persons or parties to coordinate an inspection date.

At block 1106, the inspector completes the inspection. For example, the inspector can use his or her computing device to provide GPS coordinates and timing to verify that the inspector conducted the inspection at certain location for a certain period of time on a given date. This information is transmitted from the inspector's computing device to the EMMM server (e.g. via the web portal or another type of digital interface). The inspector's computing device is also used, for example, to capture image data, video data, audio data, and other inspection or measurement information, and this data is transmitted from the inspector's computing device to the EMMM server via the web portal 150. The inspection report, which is digital data, is then stored in the EMMM server and made available to other entities via the web portal (block 1107). The inspection report, for example, identifies deficiencies in the conveyance device and sets out items for repair or maintenance, or both. The inspection report may also include deadline dates for which the deficiencies must be addressed. In some cases, an authority will suspend or revoke an operating license of a conveyance device, if a deficiency has not been addressed by a given deadline date.

Turning to back to FIG. 8, after the inspection report has been prepared, the inspection report goes to the contractor (e.g. the elevator company or elevator service provider) (block 804). The contractor then performs maintenance to address any deficiencies in the inspection report. At blocks 805 and 806, the contractor then logs into the web portal and updates responses to the inspection report (e.g. whether or not deficiencies have been cleared).

Example detail computing processes of block 804 is described in FIG. 9. Turning to FIG. 9, at blocks 901 and 902, the contractor (e.g. an elevator company) receives and accesses the inspection report via the web portal 150. For example, a notification by email, text message, or some other electronic notification, is sent to the contractor to alert them that the inspection report has been completed and is available to be accessed.

The contractor uses the web portal to assign a mechanic to work on any deficiencies in inspection report (block 903). The mechanic, who works for the contractor, uses their computing device 102 to capture and provide GPS coordinates and timing to verify that the mechanic was at the location of the given conveyance device for a certain period of time on a given date. This information is transmitted from the mechanic's computing device to the EMMM server (e.g. via the web portal or another type of digital interface). The mechanic's computing device is also used, for example, to capture image data, video data, audio data, and other test and measurement information, and this data is transmitted from the mechanic's computing device to the EMMM server via the web portal 150. The mechanic also provide his or her identifying information (e.g. certification or registration information, photo, etc.) via the web portal 150.

At block 905, the Authority accesses the information about the mechanic, and verifies that the mechanic is suitable (e.g. has appropriate license or certification) for conducting the maintenance work. Alternatively, the EMMM server has a rules database that automatically processes the information provided by the mechanic to verify that the mechanic is suitable for doing the desired maintenance work.

At block 906, the CAT test modules are captured and are uploaded and stored in the EMMM server. At blocks 907 and 908, the mechanic identifies that one or more of the deficiencies, as identified in the inspection report, have been addressed. This is reflected by the mechanic updating the inspection report via the web portal.

Turning back to FIG. 8, after block 806, it may be that after some time, a follow up inspection is required (block 807). For example, there are outstanding deficiencies, or an inspector is required to verify that the maintenance work has sufficiently addressed previous deficiencies.

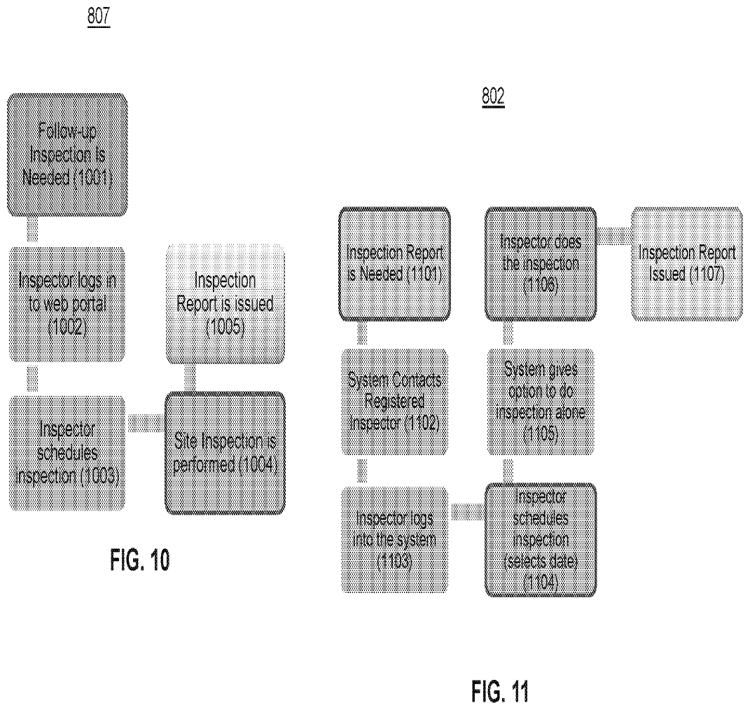

If a follow up inspection is required, then details of the computing process of block 807 are shown in FIG. 10. In particular, at blocks 1001 and 1002, after the inspector receives notification that a follow up inspection is needed, then the inspector logs into the web portal. The inspector uses the web portal to schedule an inspection (block 1003), and then performs the site inspection (block 1004). A further inspection report is issued (block 1005). This is similar to the process described with respect to FIG. 11.

If no further inspection is required (block 808), then the EMMM server shows that the given conveyance device is compliant.

The web portal 150 is also used to exchange payment and certifications amongst the different entities, including, but not limited to: state fees for inspection or reinspection (block 809); states fees for permits, licenses, etc. (block 810); paying an authority that has jurisdiction (block 811); and receiving permits, licenses, etc. (block 812).

Other aspects of the EMMM server and its monitoring capabilities are described below.

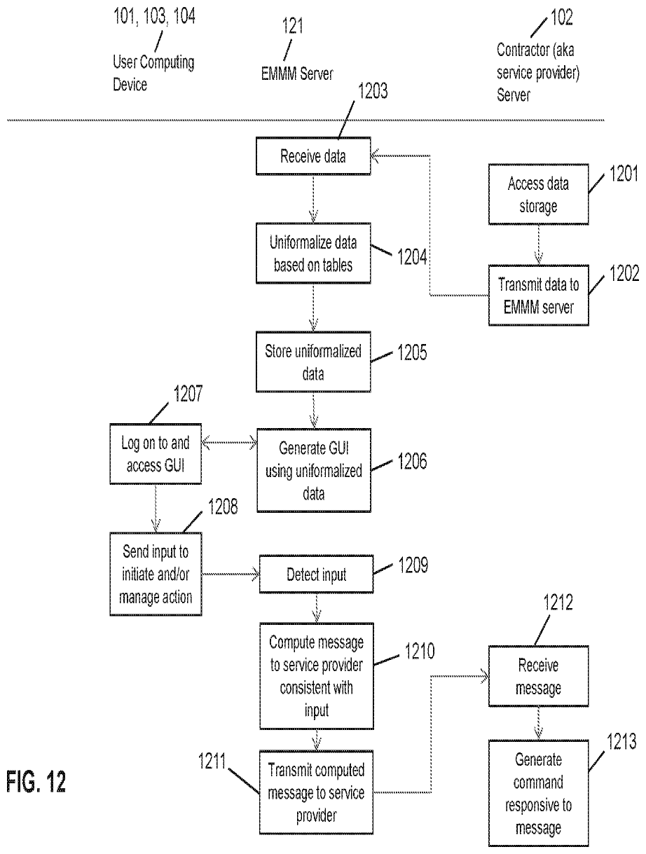

With reference to FIG. 12, example computer executable instructions are provided for data retrieval and uniformalization of elevator/escalator (referred to generally as “elevator”) maintenance and callback data. FIG. 12 relates to contractors (also called service providers) that provide maintenance and standby on call service. The service providers perform standard maintenance, and store the maintenance information on the service provider's data storage.

Furthermore, the service provider may be called (“service call”) by the user to rectify an issue with an elevating device, in which case the service provider will repair the elevator, and again store the service call information on the service provider's data storage. There is therefore information on both i) maintenance and ii) service calls on the service provider's data storage. The service provider has a web application that allows a user to log in and track the information and status of the maintenance and service call completed by the service provider. For example, the user could be an authority, an inspector, or a facility owner. At block 1201 a given service provider server or contractor server 102 accesses their data storage, and transmits that data to the EMMM server (block 1202), for example, via a web services application. Data from other entities in relation to an elevator, or other conveyance device, is also received by the EMMM server, and the EMMM server uniformalizes this data. For example, this data includes inspection data, maintenance data, permit or license data (or both), monitoring data, controller data, etc. The EMMM server receives the data (block 1203), and then uniformalizes the data based on table mappings (block 1204). The processed data is therefore in an EMMM format, which stored on the EMMM server (block 1205). For example, in the data retrieval and uniformalization process, the information using XML webservices is retrieved, uniformalized and stored on the database 210. At block 1206, the EMMM server generates a GUI and populates the GUI with the uniformalized data for display. For example, an end user can view the GUI through a web application usable on a computing device (e.g. computing devices 101, 103, 104). In particular, the user computing device logs on to the EMMM server website or application portal to access the GUI (block 1207). Through the GUI, the user computing device sends inputs to initiate an action or manage an action, or both (block 1208). The actions include, for example: initiating inspection; initiating maintenance; initiating processing of payments, licenses, or permits, or a combination thereof; and initiating and controlling callback. The EMMM server detects the input (block 1209), computes a message to a service provider that is consistent with the input (block 1210) and transmits the computed message to the service provider server (block 1211). At block 1212, the service provider server receives the message, and then generates a command responsive to the message (block 1213). The command, for example, is to send a message to an inspector, a mechanic, or both to go to the location of elevator to execute a repair or perform an inspection, or both.

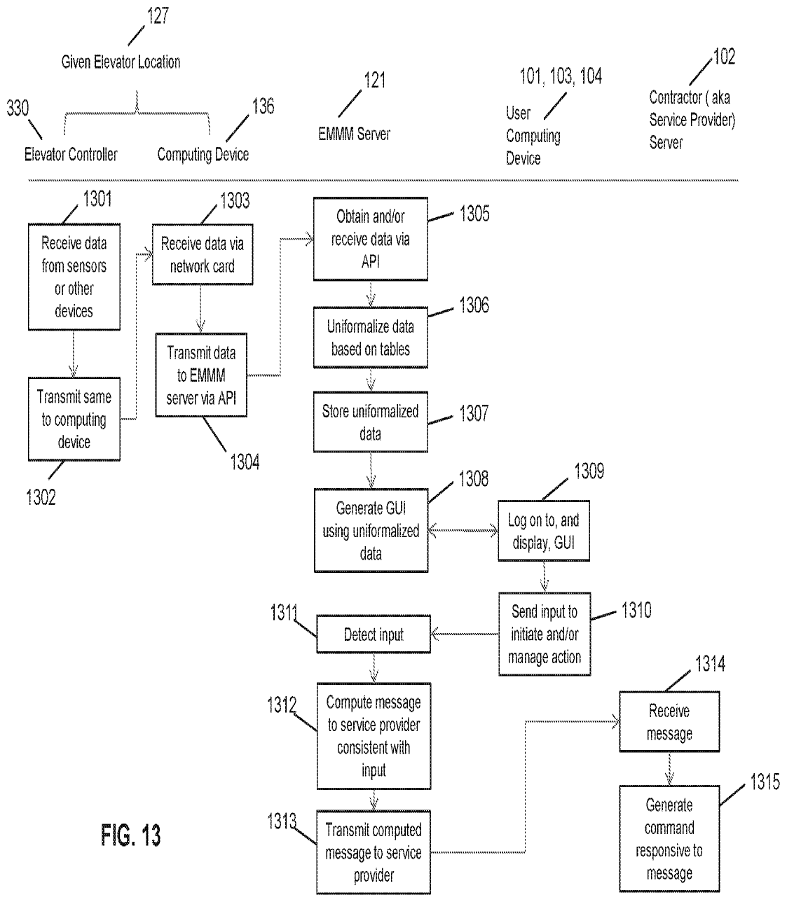

With reference to FIG. 13, another example embodiment of computer executable instructions is provided for retrieving and processing data obtained from an elevator controller. Elevator controllers, which are devices built by disparate manufacturers, are installed on the machine room and control the operation of the elevator. The controllers collect and store data regarding the performance and service of each of the elevating devices, such as storing code events. Examples of code events are Heat Detectors, Recall Activated, Landing System Sensor Fault and Emergency Power Activated. A user can see events or codes for an elevator from a computer which has a direct connection to the controller.

An example of the system receives code events using XML webservices and stores them in the database and uniformalizes them.

In the example of FIG. 13, a computing device 136 is in communication with the elevator controller 130 and is generally located at the same location (e.g. same building).

At block 1301, an elevator controller receives data from sensors and other devices. At block 1302, the elevator controller transmits the data to the computing device 136 connected to the controller. At block 1303, the computing device receives the data via a network card and then transmits the same to the EMMM server (block 1304).

At block 1305, the EMMM server obtains the data via the API, and the data is processed and stored in an EMMM format (blocks 1306 and 1307). The uniformalization includes the EMMM server using a look up table that maps specified codes and data to EMMM codes and data. At block 1308, the EMMM server generates a GUI using the EMMM formatted data. At block 1309, a user computing device is used to log on to and display the GUI. At block 1310, the user computing device detects user input and sends the input to initiate or manage, or both, an action. At block 1311, the EMMM server detects this input and then computes a message to the service provider consistent with the input (block 1612). This message is transmitted to the service provider server (block 1313). The service provider server receives this message and generates a command responsive to the message (blocks 1314 and 1315).

Any number of various elevator controllers store code events through its connection with the elevator sensors. The code events stored in the manufacturer controller are transmittable to a remote computer via a manufacturer network card. A manufacturer application and API would generally be installed to allow remote access by the user. The manufacturer application and API transmit data to web services application. As noted above, the EMMM server retrieves the data from the network via the web services application. The data is uniformalized and stored. The uniformalized data may be presented through an intuitive web application, such as in the GUI. The end user sees data regarding the code events that have been created by an elevator.

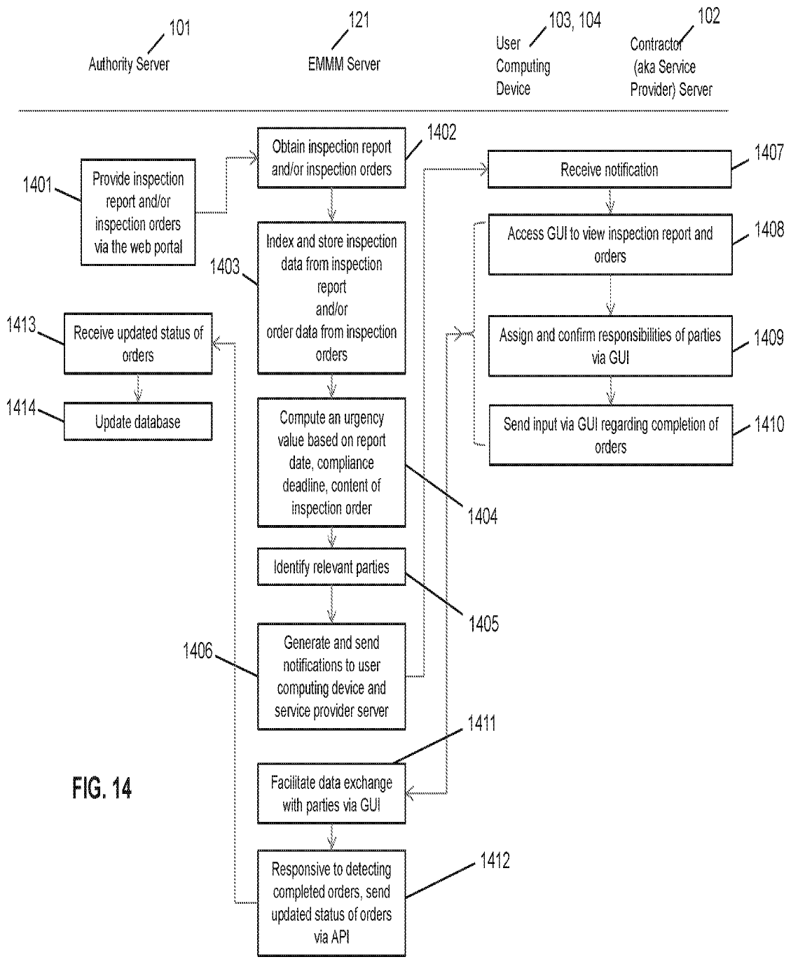

FIG. 14 shows example computer executable instructions for managing an inspection process. At block 1401, the authority provides an inspection report or a request for an inspection report (e.g. also called inspection orders), or both, via the web portal. At block 1402, the EMMM server obtains the inspection report or inspection orders, or both. At block 1403, the EMMM server indexes and stores the inspection data from the inspection or the order data from the inspection orders, or both. The inspection order includes an identifier of the facility owner, the date of inspection, and one or more identifiers of the elevators (e.g. elevator cars A and Bin location A). The inspection orders may include an issue date identifying the date at which the order was issued by the safety monitoring server, and a deadline date identifying the deadline at which the order is to be completed. The order may also include a regulation code or regulation identifier that refers to a specific regulation or rule. The order includes text that identifies an action to be performed by the facility owner or the service provider contracted by the facility owner. The text in the order may also include components of the elevator that require repair, monitoring or maintenance. It will be appreciated that the data items in an inspection order or inspection report, or both, may vary from what is described above.

The EMMM processes this data. For example, the data items are itemized and indexed and compared against rules and other values. In another example, the text is analysed using natural language processing to determine actions and relevant components of the elevator system.

At block 1404, the EMMM server computes an urgency value based on a number of factors, including one or more of: the date that the report was issued, the compliance deadline date, the current date, and the content of the inspection order. For example, if the compliance deadline is approaching, then the urgency value is higher. If the text content of the inspection order indicates that an action is not critical to the safety or function, then the urgency value is lower. Otherwise, if the text content indicates that an action or a component is critical to the safety and function of the elevator, then the urgency value is higher.

At block 1405, the EMMM server identifies the relevant entities and their contact information from a database stored on the EMMM server. At block 1406, the EMMM server then generates or compiles notifications, and sends these notifications to the identified entities (e.g. a computing device of the facility owner, a computing device of an inspector, and a computing device of the service provider).

A number of operations (blocks 1407 to 1410) may be performed by one or more of the computing device 103, 104, 102. These operations include an exchange of data with the EMMM server via a GUI (block 1411). In particular, one or more of the computing devices 103, 104, 102 execute the following instructions: receive the notification (block 1407); access the GUI to view the inspection report and orders (block 1408); assign and confirm responsibilities of parties via the GUI (block 1409); and send an input via the GUI regarding completion of orders (block 1410). Responsive to the EMMM server detecting the completed orders, the EMMM server sends an updated status of the inspection orders to the authority 101 via the web portal (block 1412).

In an example embodiment, the EMMM server sends reminders to one or more of the computing devices 103, 104, 102, if the order status is not completed.

At block 1413, the authority receives the updated status of the inspection orders and updates its own database (block 1414).

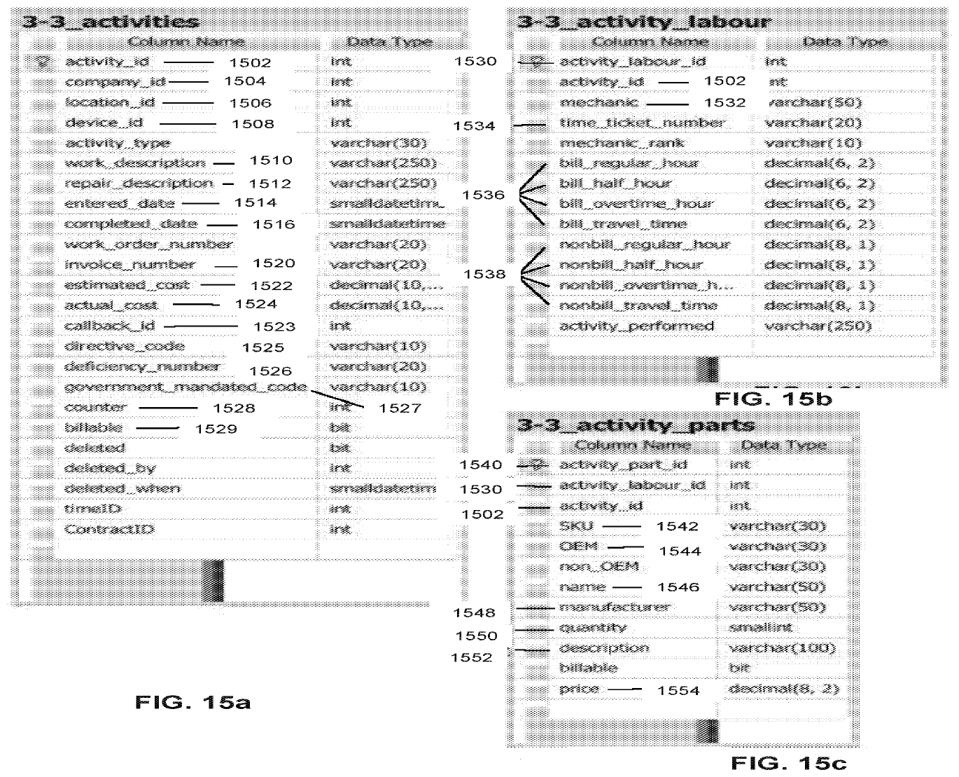

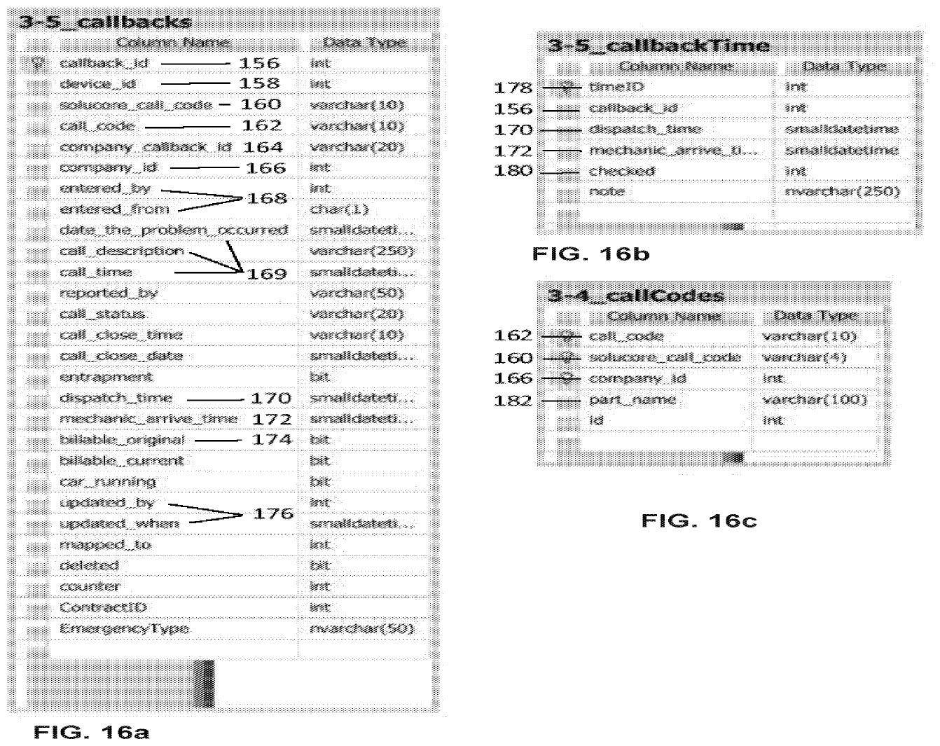

With reference to FIGS. 15a to 15c and to FIGS. 16a to 16c, example datasets are shown from databases stored in the EMMM server. In FIG. 15a, table Activities contains activities having a unique activity id 1502, a company id 1504, a location id 1506 which is tagged to the location of the elevating device, and a device id 1508, to identify a unique elevating device. The maintenance information is stored in the form of work description 1510, repair description 1512, the entered and completion dates 1514, 1516 and the work order number 1518. The invoicing information may be contained as invoice number 1520, estimated cost 1522 and actual cost 1524. The callback information includes a callback id 1523, directive code 1525, deficiency number 1526, government-mandated code 1527, counter 1528 for the number of occurrences, and billable 1529 that determines whether the hours are billable or not.

In FIG. 15b, table Activity Labour contains a unique labour id 1530, the name of the mechanic 1532, the ticket number 1534, the hours spent at various rates per hour (regular hour, half hour, overtime and travel hours) 1536, as well as time spent at nonbillable activities 1538.

In FIG. 15c, table Activity Parts provides information on the parts used for the elevator repair. The part id 1540 is a unique identifier, and also includes a SKU number 1542, OEM field 1544, and the name and manufacturer of the part 1546, 1548, along with quantity of parts 1550, description 1552 and price 1554.

In FIG. 16a, table Callbacks includes callback ID 156 for a unique record ID, device ID 158 to uniquely identify a device, a unique call code 160, call code 162, company callback ID 164, company ID 166, information regarding about the problem that occurred such as who entered the problem 168, the date, time and description of the problem 169, dispatch time 170, the call status 171 (including call status and call close time and date), mechanic arrive time 172, information regarding billable hours 174, as well as other information regarding updates of the system 176 such as who updated it or when the update occurred.

In FIG. 16b, table Callback Time contains time 178, callback ID 156, dispatch time 170, and mechanic arrive time 172 to determine the responsiveness of the mechanic's call.

In FIG. 16c, table Call Codes contains call code 162, a further call code 160 to map the service provider code with business partner code and uniformalize the data, company ID 166, and part name 182 to produce the call codes.

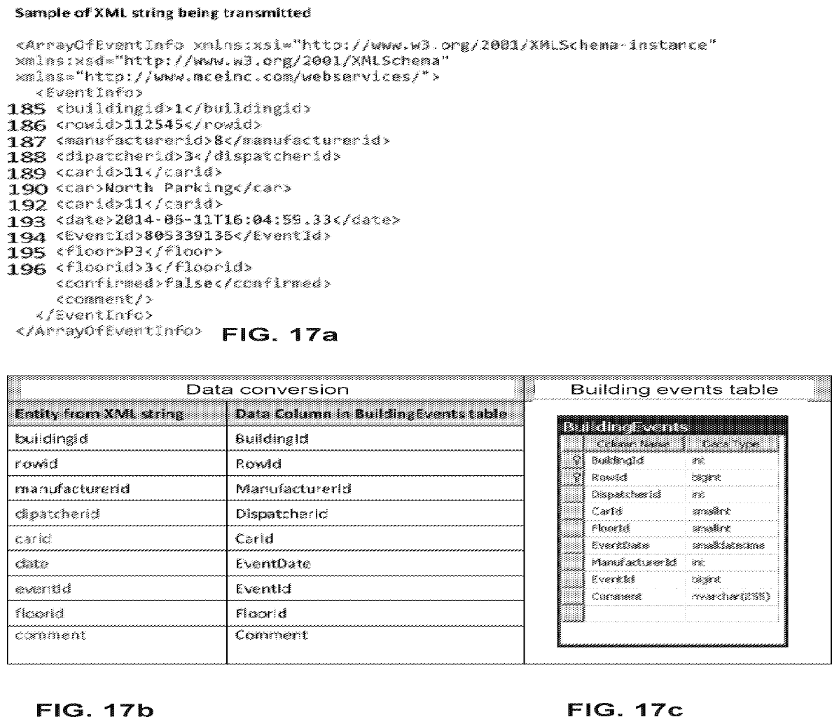

With reference to FIG. 17a, an example of an XML string being transmitted from a computing device 1600 connected to a controller, to thraye EMMM server 301 is shown. In this example, the XML string transmits data on the building ID 185, which is a unique identifier of the building, row ID 186 of the table, the manufacturer ID 187 of the elevating device, the dispatcher ID 188, the car ID 189, a car name 190 for the elevating device, a date stamp 192, an event ID 193 which uniquely identifies the occurrence, along with the floor 195 where the incident occurred, and whether the event was confirmed 196.

In FIG. 17b, an example embodiment of data conversion or uniformalization is shown, wherein the data from the XML string is uniformalized into tables of the datastore, in this example of the Building Events Table. The buildingid field is placed into the BuildingId field, the manufactureid into the ManufactureId field, and so on.

In FIG. 17c, an example of the data types of the Building Events Table is shown. These fields in the table have data restrictions. For example, BuildingId is an integer, while RowId is a big integer, and CarId is a small integer and comment is a 255-character field that can hold various characters. In the data conversion process the data from the XML file is received and entered into the fields within the datastore's tables, under the restrictions of the various fields of the tables. Fields may be limited in different ways (such as varchar [127] or int [3]), and where the data does not fit, it is truncated or converted before being inserted into the database. For example, varchar [255] will be truncated to fit varchar [127], and a decimal number will be rounded to fit an integer data slot. In this way, the data is uniformalized into a single database. In an embodiment, inconsistencies of the field naming convention between the XML (representing the manufacturer's specification) and the tables of the datastore are resolved by means of a mapping table, wherein the names used by the XML incoming data are matched to the correct fields of the datastore.

The EMMM server also identifies critical time periods of an elevator and, based on whether or not the current time is within a critical time period, the EMMM server executes different sets of computations. A critical time period for an elevator is a time period during which an elevator is being used frequently by many people. Based on the type building in which a given elevator is located, the date, and other factors, for example, the EMMM server is able to automatically determine the critical time periods for the elevator. For example, the EMMM server uses rules to conclude that, if the building is a business building, then the critical time periods are on the weekdays in the morning hours, the lunch time hours and afternoon hours. If the building is a residential building, then the critical time periods are in the morning hours and the afternoon hours on weekdays.

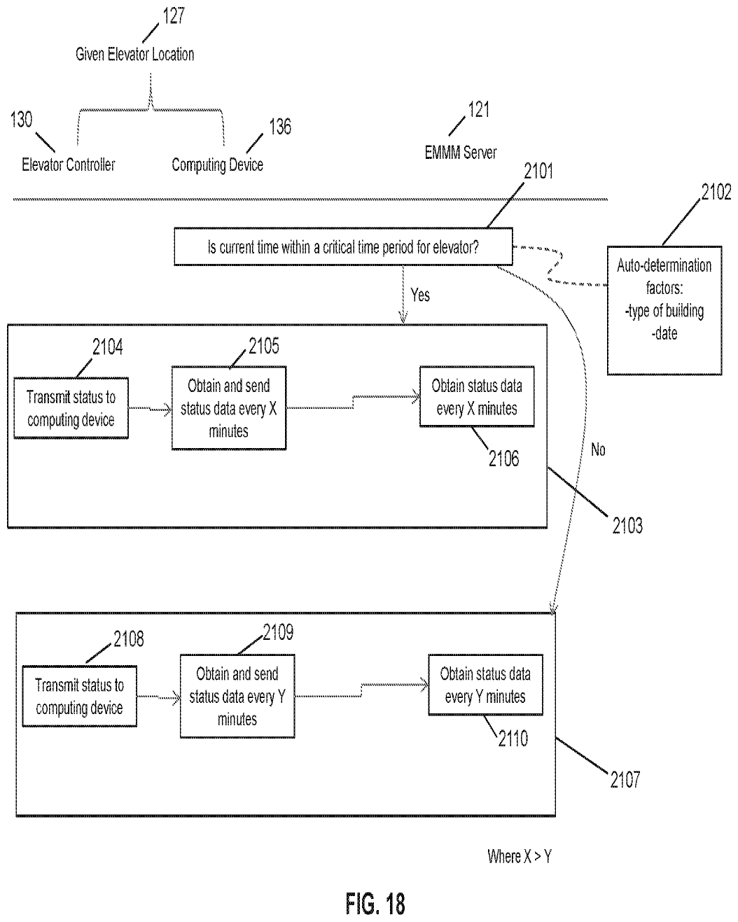

FIG. 18 shows example computer executable instructions for adjusting the executed instructions for the EMMM server 121 or the computing device 136 connected to the controller, based on a critical time period. At block 2101, at least one of the computing device 136 and the EMMM server 121 determine if the current time is within a critical time period for a given elevator. In an example embodiment, the EMMM server automatically determines the critical time periods based on one or more factors, including the type of building, and the current date (block 2102). In another example, the critical time periods may be inputted by a user or modified by a user.

If the current time is within a critical time period, then operations 2103 are executed. These include the elevator controller transmitting status information of the given elevator to the computing device every X minutes (block 2104), the computing device obtaining and sending this information to the EMMM server every X minutes (block 2105), and the EMMM server obtaining the status information from the computing device every X minutes (block 2106). X is a number, and may be a decimal number.

If the current time period is not within a critical time period, then different operation 2107 are executed: blocks 2108, 2109 and 2110. These are similar to blocks 2104, 2105 and 2106, but the data is obtained every Y minutes. Y is a number (e.g. a decimal number) that is less than X. In other words, if the current time is not in a critical time period, then the EMMM server obtains the elevator data less often. While if the current time is in a critical time period, then the EMMM server obtains the elevator data more frequently. In this way, if an error occurred, it would be more quickly reported to the facility owner and the service provider during a critical time period.

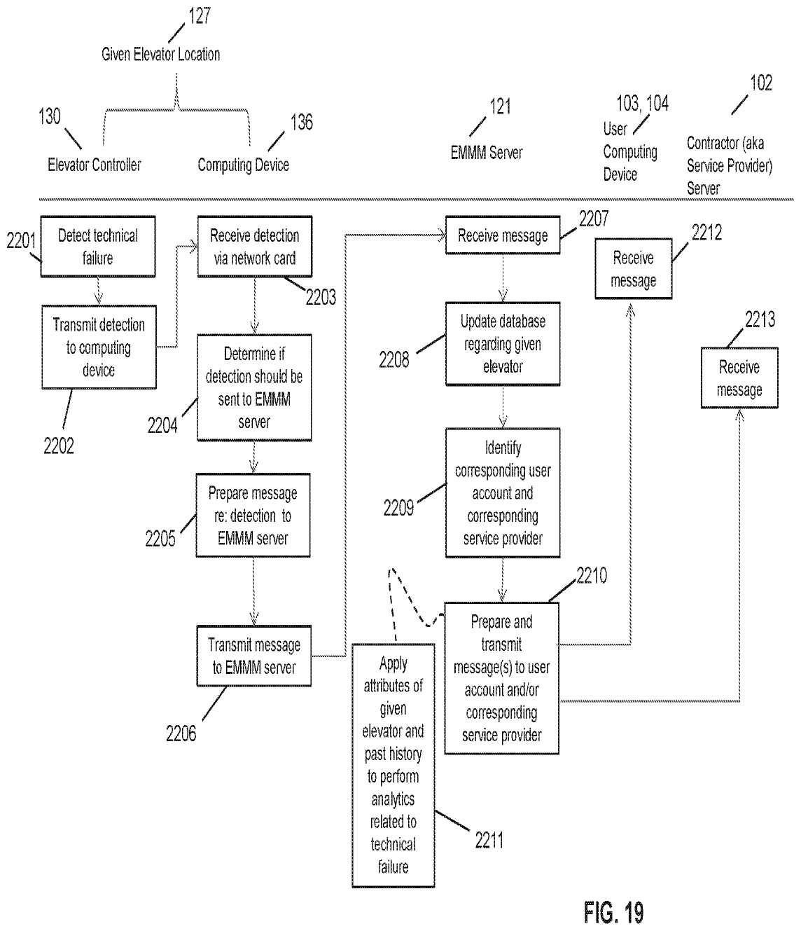

Turning to FIG. 19, example computer executable instructions are provided for transmitting notifications of a technical failure. At block 2201, the elevator controller 130 detects technical failure and then transmits the detection to the computing device 136 (block 2202).

The computing device receives the detection via the network card (block 2203) and determines if the detection should be sent to the EMMM server (block 2204). The determination may be made according to one or more different computing algorithms.

If the computing device determines the detection should be sent, then at block 2205 the computing device compiles a message regarding the detection to the EMMM server. The message is transmitted at block 2206.

The EMMM server receives the message (block 2207) and updates the database regarding the given elevator (block 2208). The EMMM server identifies the corresponding user account of the facility owner and the corresponding service provider of the given elevator (block 2209). At block 2210, the EMMM server prepares and transmits one or more messages to the user account (e.g. the user's computing device) and the corresponding service provider (e.g. the service provider's server). At block 2211, the EMMM server may optionally apply attributes of the given elevator, the received message, and the past history of the given elevator to perform analytics related to the technical failure.

At blocks 2212 and 2213, the user computing device 103,104 and the service provider server 102 respectively receive the message from the EMMM server.

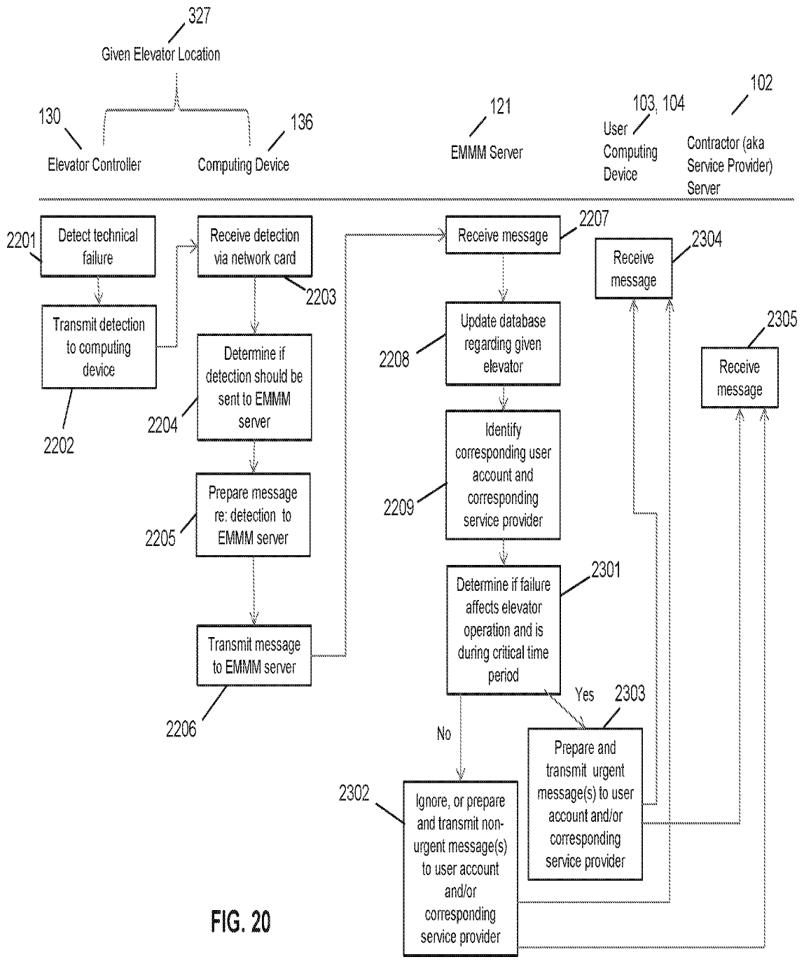

FIG. 20 shows example computer executable instructions similar to those in FIG. 19, but the computations consider the critical time period. Operations in blocks 2201 to 2209 are executed. After, at block 2301, the EMMM server determines if the detected failure affects elevator operation during a critical time period. If so, at block 2303, the EMMM server prepares and transmits an urgent message or messages to the user computing device or the service provider server, or both. If not, at block 2302, the EMMM server ignores the message, or prepares and transmits a non-urgent message. The user computing device or the service provider server, or both, receive the messages (blocks 2304 and 2305).

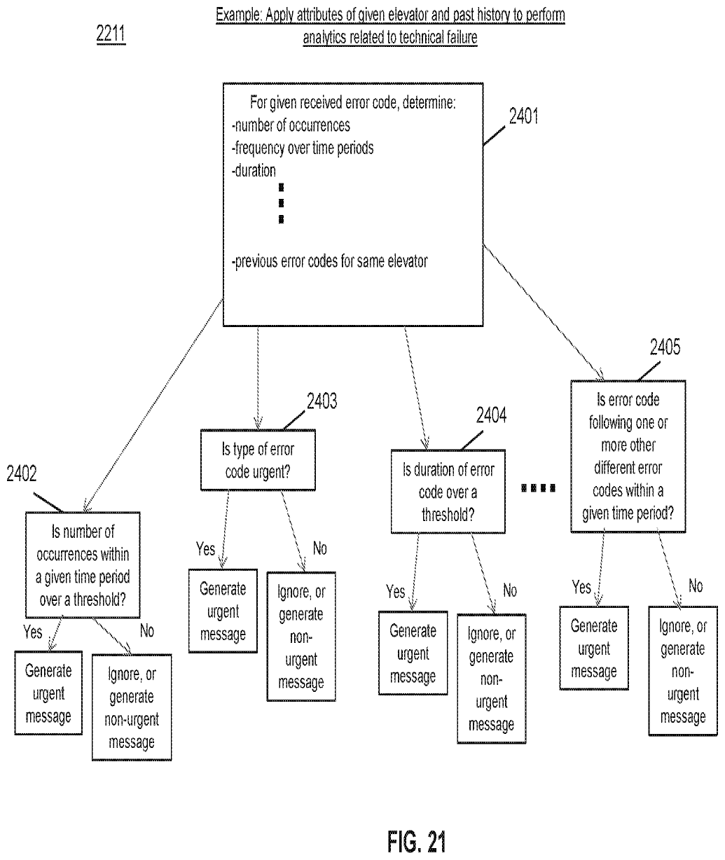

FIG. 21 shows example computer executable instructions for performing block 2211 to perform analysis of the technical failure.

At block 2401, the EMMM server determines related information about the given error code including: the number of occurrences of the same error code, the frequency of the error code within a given time period, the duration of the error code, and previous error codes for the same elevator. There may be other related information obtained, such as past repairs, related inspection reports and related inspection orders.

At block 2402, the EMMM server determines if the number of occurrences within a given time period is over a threshold. If so, an urgent message is generated.

At block 2403, the EMMM server determines if the type of error code is urgent. If so, an urgent message is generated.

At block 2404, the EMMM server determines if the duration of the error code is over a threshold. If so, an urgent message is generated.

At block 2405, the EMMM server determines if the error code follows one or more different error codes within a given time period. For example, certain combinations of different error codes may reveal an urgent problem, or reveal that the problem is not urgent. If the rule is satisfied, then the EMMM sever generates an urgent message.

It will be appreciated that there may be other rules or conditions that the EMMM server uses to determine whether or not an urgent message should be generated and sent.

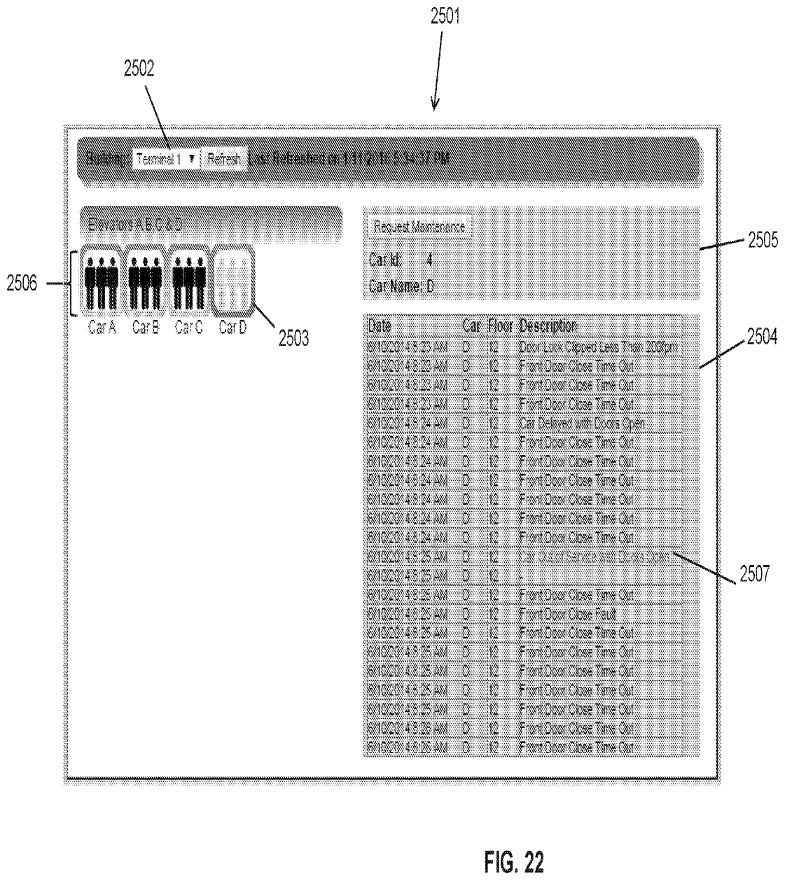

FIGS. 22 to 25 show example portions of GUIs generated by the EMMM server.

FIG. 22 shows a GUI 2501, or portion thereof, showing details about multiple elevator cars in a building. The control 2502 allows a user to select a certain building. The elevators cars in the selected building are shown as buttons 2506. When one of elevator car buttons are selected, the details of the elevator car are shown in display portions 2505 and 2504. In this example, the button for car D 2503 is shown in a different color or shape to visually indicate that there is an error for car D.

As shown in portion 2505, there is a button that, when selected, initiates automatic compilation of a message to request maintenance of the selected car (e.g. elevator car D). The display, and message should it be compiled, shows the car Id and the car name. The portion 2504 shows a list of events. Each event includes, for example, a date and time stamp, the relevant floor, and the description of the event. The event 2507 in the list that is an error event is shown in a different color or identified by some other visual indicator. For example, the event 2507 indicates that the car is out of service with doors open.

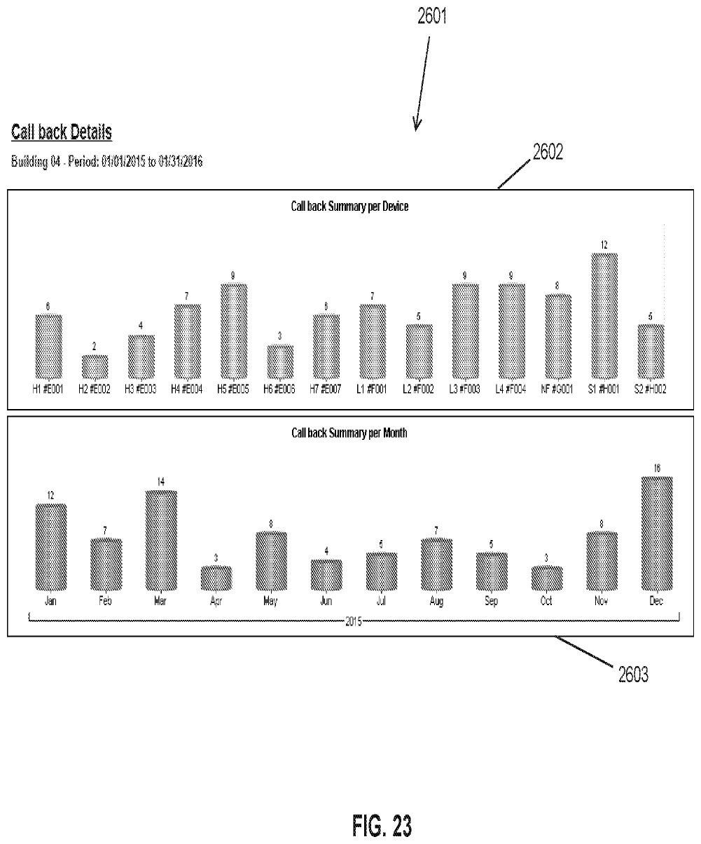

FIG. 23 shows an example summary of call back details in the GUI 2601, or portion thereof. The GUI includes a graph 2602 showing the number of callbacks made for each lift device. The graph 2603 shows a number of callbacks made per month for all the lift devices belonging to the facility owner.

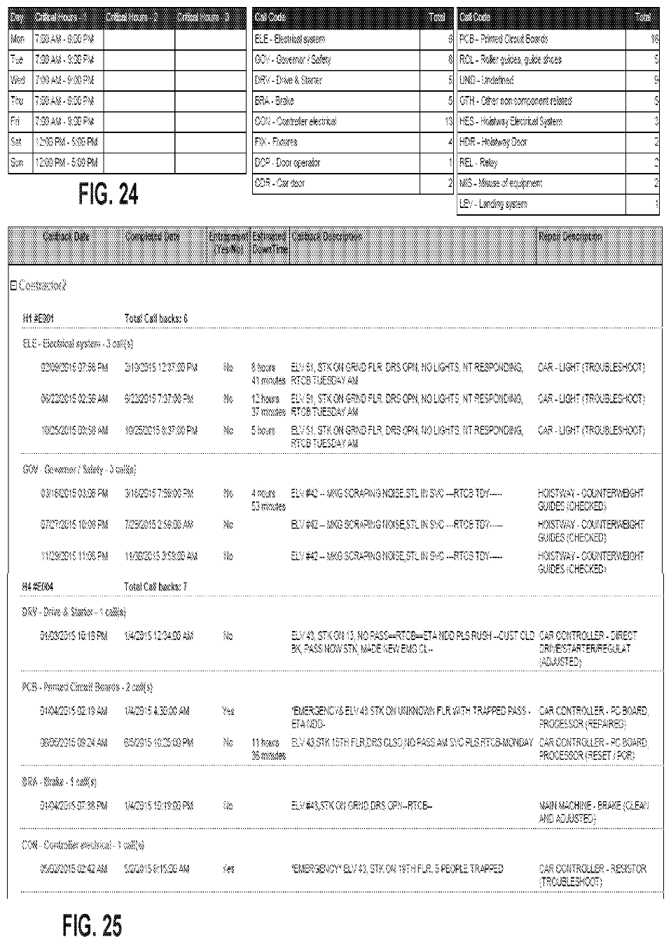

FIG. 24 shows time period for critical hours and error codes for according to the EMMM format.

FIG. 25 shows a report that includes the history of error codes for a given elevator. For example, elevator H1 #E001 has a total of six call backs: three call backs associated with the ELE error code (e.g. electrical system) and three call backs associated with the GOV error code (e.g. governor/safety). Each error instance shows the date the error code was transmitted, the completion date of the repair, whether or not entrapment occurred, the estimated down time of the given elevator, the description of the error, and the description of the repair.

In an example embodiment, based on the analytics, the EMMM server will automatically recommend repairs, predict maintenance, and identify root problems. These recommendations and automatic analysis may also be presented in the GUI.

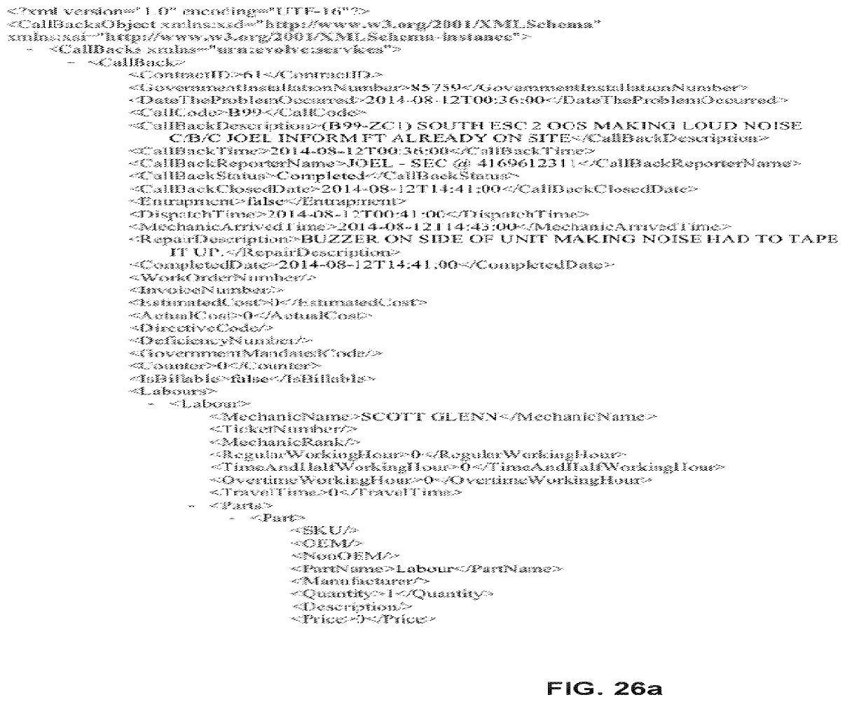

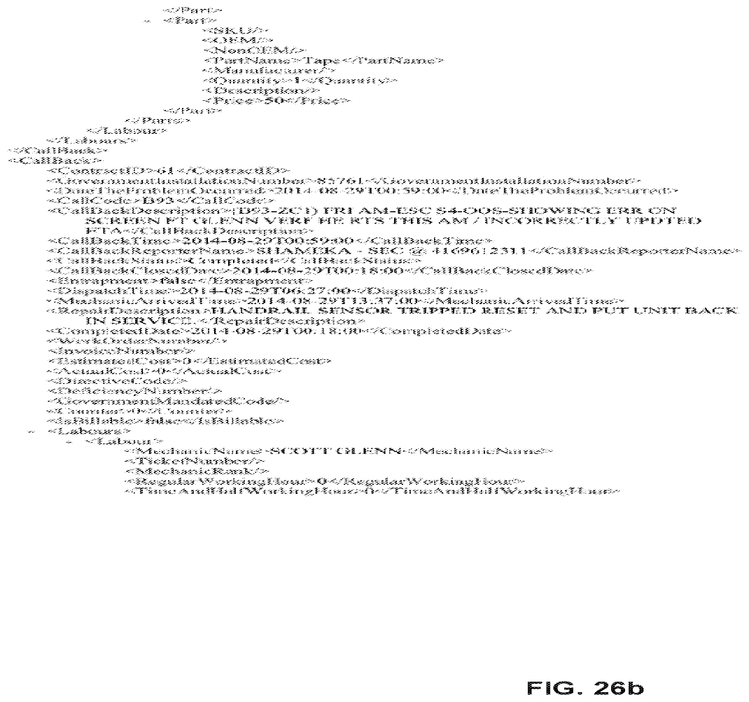

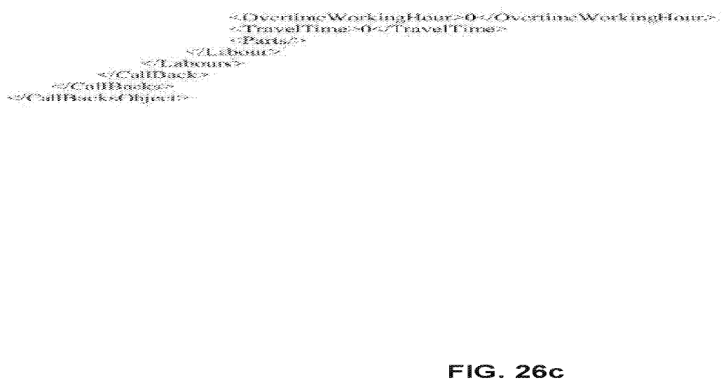

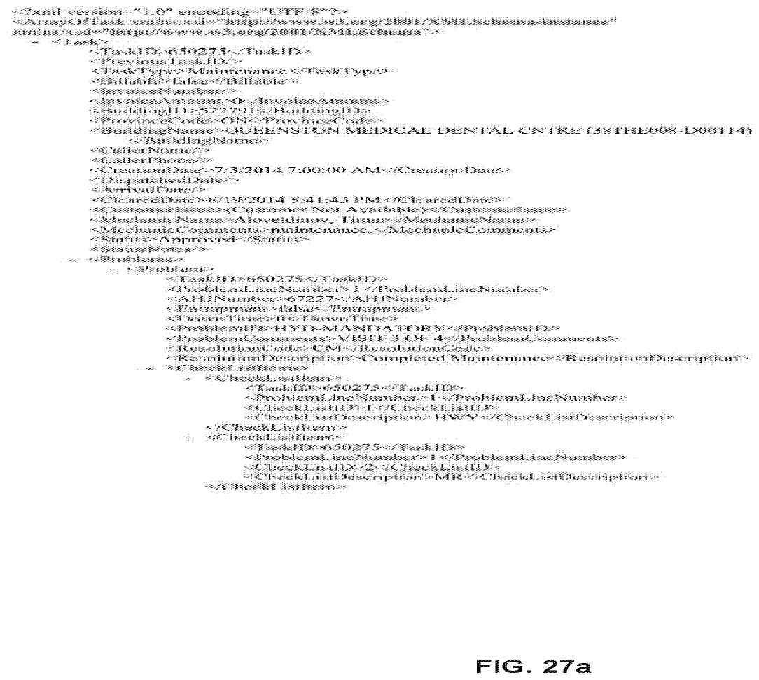

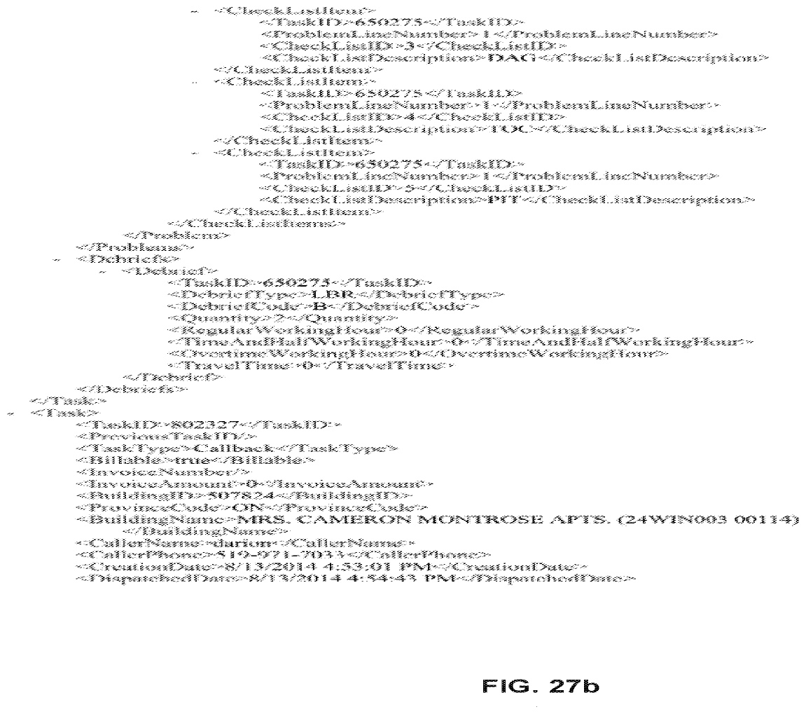

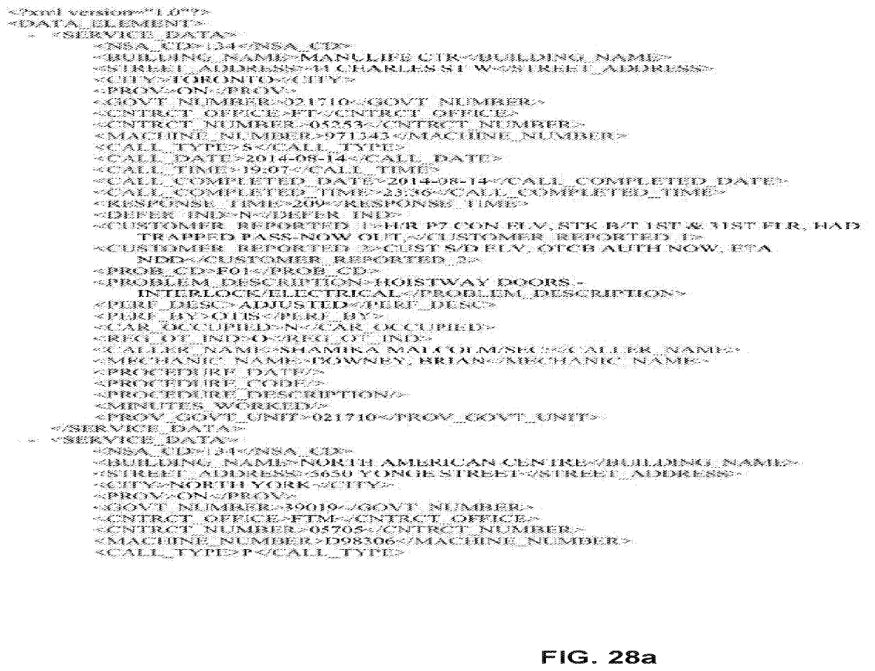

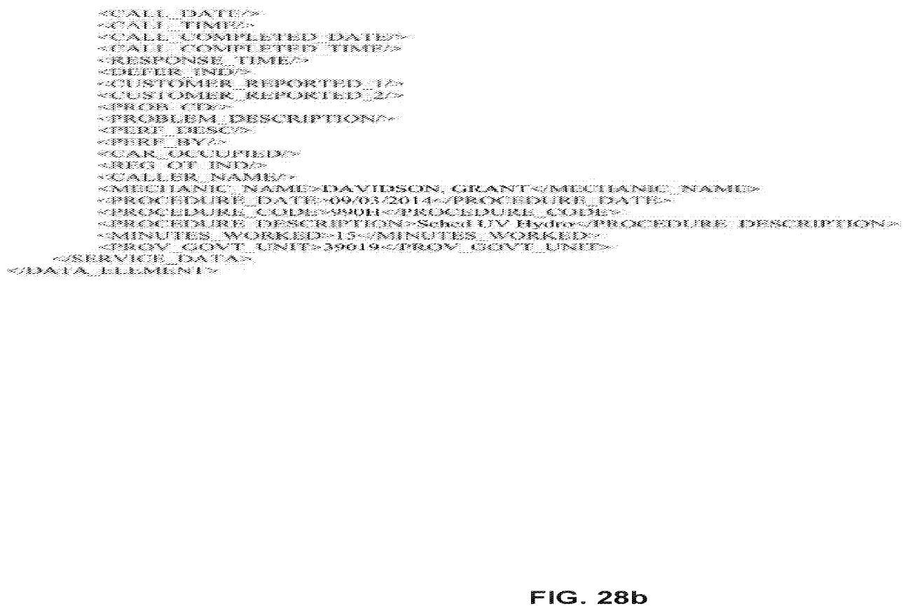

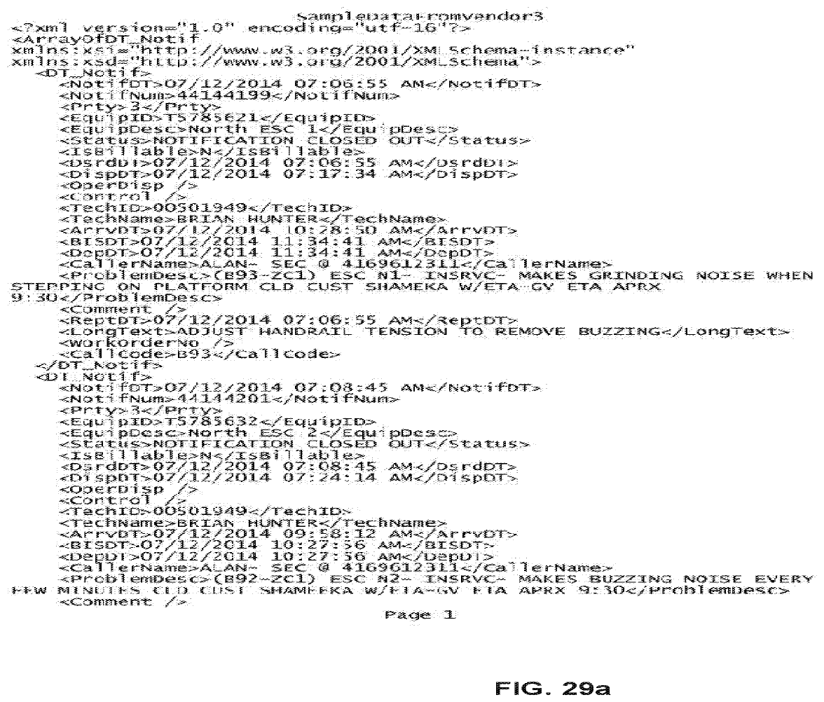

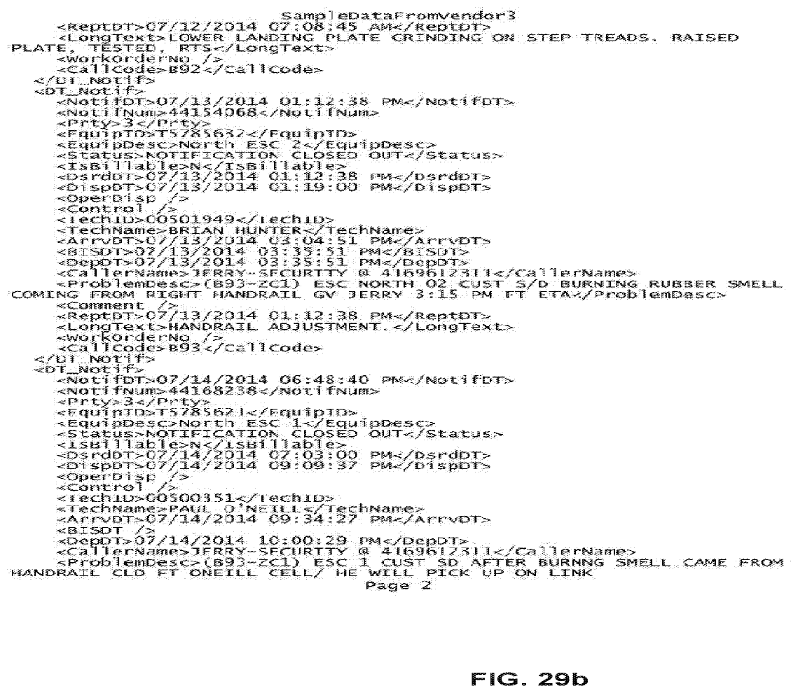

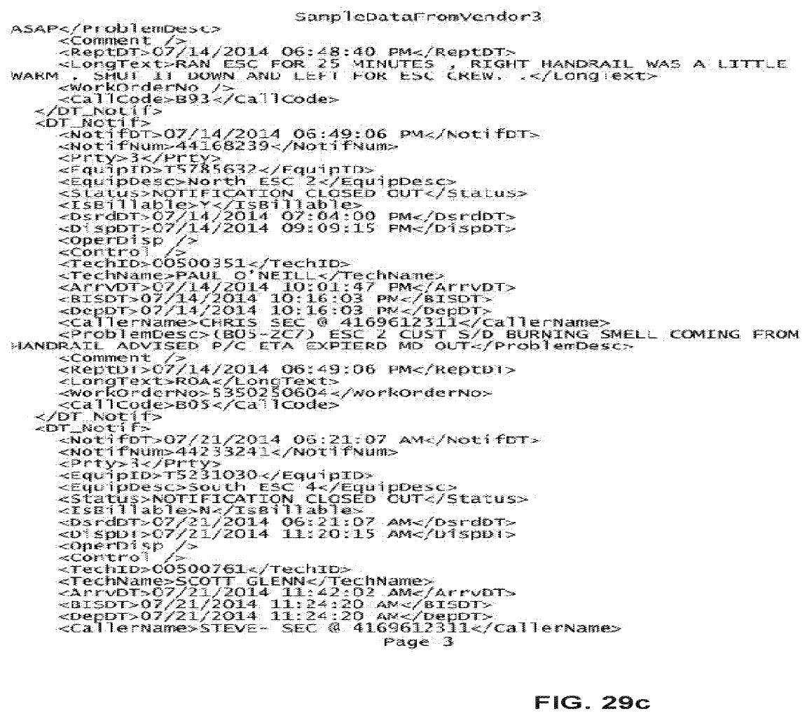

FIGS. 26a to 26c, 27a, 27b, 28a, 28b and 29a to 29c show further examples of XML data from Vendors that is used to encapsulate the maintenance history of an elevating device.

Further example aspects are provided below.

With uniformalization of maintenance and usage data, there is a single sign on. The end user can control callback, allowing the end user to notify different concerned parties, such as owners, service providers, consultants and building tenants, to avoid any unwanted events, as well as send reminders of any kind. Further, uniformalization allows the end user to view information from multiple service providers in one standard presentation, instead of multiple reports in multiple formats. The end user can access information at anytime, providing access to the most recent information on their equipment. Further, information is backed up in the business partner facility. Therefore, the end user can access historical data even after switching service providers. Additionally, backup of data within the business partner's facility provides protection to the end user in the event of a data failure. Having the multiple datasets uniformalized enables the business partner application to analyze datasets, show performance and deficiencies, and send out notifications to the concerned parties.

Other example embodiments and aspects are provided below.

In a general example embodiment, a method is provided for data retrieval and uniformalization for conveyance devices. It includes: a web server providing a web portal; the web server obtaining conveyance device data in different formats from different service providers, via the web portal, the conveyance device data comprising conveyance device performance data and data related to conveyance device maintenance, and the different formats corresponding to different types of conveyance device controllers; the web server uniformalizing the conveyance device data and then storing the same; and the web server providing access to the web portal to one or more entities ancillary to the different service providers. Uniformalizing the conveyance device data includes: determining a mapping for the conveyance device data into a database of the web server, wherein the database of the web server has data restrictions; and converting said conveyance device data to match said data restrictions.

In an example aspect, the data is xml webservices data and the conveyance device data is retrieved, uniformalized and stored on a datastore.

In another example aspect, the method includes installing a manufacturer application and API, wherein said manufacturer application and API transmit data to the web portal.

In another example aspect, the one or more entities comprise an inspector and an authority.

In another example aspect, the method includes the web server receiving an inspection order via the web portal from the authority and, in response, the web server transmitting an electronic notification to the inspector to conduct an inspection of the conveyance device.

In another example, aspect, the web portal displays a scheduling graphical user interface (GUI) to the inspector to schedule the inspection of the conveyance device.

In another example aspect, the web portal receives inspection report data from the inspector, and wherein the inspection report data and the inspection order are accessible by one or more of the different service providers via the web portal.

In another example aspect, the web server automatically generates one or more actions for the one or more different service providers based on rules that invoked by the inspection report data, and the web server transmits an electronic notification of the one or more action to the one more different services providers regarding the one or more actions.

For example, there is a rule that states that if there are more than x number of failure events within a year, then an inspection must be carried out, or maintenance must be carried out, or both. Accordingly, notification to the inspector or the contractor, or both, is provided.

The failure events can be obtained from the computing device 136 at a given location 127, or by public submitting reports via the web portal 150, or by inspectors submitting information via the web portal 150, or a combination thereof.

In another example aspect, the one or more actions comprise the one or more different service providers initiating a maintenance call.

In another example aspect, the web server analyzes datasets, displays performance and deficiency information, and sends out one or more electronic notifications to the one or more entities.

In another general example embodiment, a web server system is provided for data retrieval and uniformalization for conveyance devices. The web server system includes: memory storing thereon a web portal; a communication system that is configured to obtain conveyance device data in different formats from different service providers, via the web portal, the conveyance device data comprising conveyance device performance data and data related to conveyance device maintenance, and the different formats corresponding to different types of conveyance device controllers; and one or more processors on the web server system. These one or more processors are configured to at least: uniformalize the conveyance device data and then store the same in the memory; and provide access to the web portal to one or more entities ancillary to the different service providers. Uniformalizing the conveyance device data comprises: determining a mapping for the conveyance device data into a database of the web server, wherein the database of the web server has data restrictions; and converting said conveyance device data to match said data restrictions.

In another example embodiment of the system and the method, a server (e.g. the EMMM server) obtains code events about a lift device controller via a web services application, the code events being in a first format. The server reformats the code events into a second format using a mapping table, and outputs reformatted code events. The server populates a graphical user interface (GUI) with the reformatted code events, whereby the GUI is accessible by another computing device over the Internet.

In an example aspect, reformatting the code events comprises: selecting a mapping for the code events from a database comprising multiple mappings, the selected mapping selected based on a manufacturer of the lift device, and the database on the server has data restrictions; and converting the code events to match said data restrictions.

In another example aspect, the server receives the code events as part of XML web services data.

In another example aspect, the server obtains data about multiple lift devices associated with a common owner, and the data associated with the multiple lift devices, including the event codes, are shown simultaneously in the GUI.

In another example aspect, the multiple lift devices are located at different locations, and the different locations are shown in the GUI.

In another example aspect, the GUI comprises a control to initiate generating a message, and the operations further include: detecting selection of the control; identifying the lift device currently being selected in the GUI; identifying contact information of a service provider associated with the selected lift device; and automatically compiling the message that includes information about the selected lift device, the message including the contact information.

In another example aspect, automatically compiling the message includes inserting one or more of the event codes associated with the selected lift device.

In another example aspect, the GUI displays information from one or more service providers.

In another example aspect, the operations further include analysing the received event codes to provide an assessment of the lift device.

In another example aspect, the assessment determines an urgency level, and when the urgency level is high, the server sends a message to a user account associated with the lift device.

In another example aspect, the analysing includes comparing the received event codes with past event codes for the same lift device. In another example aspect, the analysing includes identifying a number of the received event codes within a given time period. In another example aspect, the analysing includes identifying a time duration associated with the received event codes. In another example aspect, the assessment includes determining if at least one of the received code events occurred during a critical time period associated with the lift device.

In another example aspect, the operations further include the server receiving an inspection order that includes an identifier of the lift device and a compliance deadline, the inspection order transmittable by a safety monitoring server; in response, the server identifying a user account associated with the lift device; and the server automatically compiling and sending a notification to the user account comprising the inspection order.

In another example aspect, the operations further include the server receiving an input that the inspection order is complete via the GUI; and, in response, the server sending a status message comprising the identifier of the lift device via an application programming interface (API), the status message receivable by the safety monitoring server.

In another example aspect, the lift device is at least one of an elevator and an escalator.

In another general embodiment, a computing process for processing safety data related to one or more lift devices, includes: a server receiving an inspection order via an application programming interface (API) that includes an identifier of a given lift device and a compliance deadline, the inspection order transmittable by a safety monitoring server; in response, the server identifying a user account associated with the given lift device using a database on the server; and the server automatically compiling and sending a notification to the user account comprising the inspection order.

In an example aspect, the server receives an input that the inspection order is complete via a GUI provided by the server; and, in response, the server sends a status message comprising the identifier of the lift device via the API, the status message receivable by the safety monitoring server.

Sensors, particularly but not limited to cameras, can be combined with machine learning to enable a computing device (whether an EMMM server or another device) to understand real-world activities in the elevator (in one example, this can be done using computer vision: methods of acquiring, processing, analyzing and understanding digital images from the real world to produce numerical or symbolic information, including decisions). Real world events of or around the lift device/elevator may be referred to as device events. Converting information from sensors to an understanding of device events can then be used to understand or map the meaning of codes from elevator controllers, and in turn this can allow improved remote monitoring and management of elevators (or, more broadly, lift devices including escalators), and in some cases may be necessary for the remote monitoring and management of lift devices.

In a preferred embodiment, each elevator will have three sensors: one observing the top of the elevator, one observing the bottom or underside of the elevator, and one located in the elevator itself. In a preferred embodiment, these sensors are cameras. A person skilled in the art will appreciate that the placement of these sensors will determine what real-life or device events can be observed and detected through the sensors. A person skilled in the art will also appreciate that sensors can be added or removed, and this will also determine what real-life lift device events can be observed and detected through the sensors. For additional information, a camera or more broadly a sensor can be installed in the machine room and/or at the top of the shaft.

As discussed above, each elevator or lift device will have a controller installed by the manufacturer of the elevator. This controller will generate a series of codes or code events data as events happen in real time. These typically include codes for: elevator door open; elevator door close; elevator brakes on/off; elevator going up; elevator going down, door is blocked and unable to close; the emergency button has been pressed; as well as codes related to the hall door (i.e. the door that is seen by the user as they wait for the elevator to arrive). These codes are unique to each elevator (or lift device) manufacturer, and generally are kept confidential. A building or lift device manager in some situations has access to the stream of codes from the elevator controller, but not the ability to understand them in real time, making the codes irrelevant to the real time remote monitoring and management of elevators and other lift devices.

These codes can be quite detailed and provide a fine grain of information about lift device operation. For example, for an elevator to go up, codes might be generated by the controller corresponding to: close the elevator and hall-side doors, lock the hall side door, lock the elevator door, a direction (up or down) indicator, release the brakes on the elevator, start moving (called the drive), move at slow speed, transition to higher speed, move at high speed, transition to slower speed, move at slow speed, stop, apply brakes to the elevator, unlock the elevator door, unlock the hall side door, and open the hall side and elevator doors.

By storing and tracking the codes and correlating the codes with real life events as recognized by the sensors using machine learning or computer vision, a mapping can be created by a computing device correlating the codes to real life events, also known as device events.

For example, when a person on the fifth floor of a building presses the up button, a code is generated by the controller reflecting this. By seeing the elevator go the fifth floor, a correlation or mapping can be realized between that code and the real-life device event of someone summoning the elevator to the fifth floor. Similarly, if a maintenance person accesses the top inspection station switch (which is located on the top of the elevator), the controller will generate a code to reflect this, and by using sensors/cameras on top of the elevator, this code can be correlated to the real-life device event of access of the switch.

Once an initial mapping of code events data to real life device events has been determined, the sensors and machine learning can continue to refine the mapping of code events data to real life device events, including creating new mappings when rare or irregular real life device events occur, or if changes are made to the codes by the elevator manufacturer (for example, if a new version of the controller or manufacturer software is released). The sensors and machine learning can perform ongoing quality checks upon the mapping of the code events data to real life device events.

Once the relationship between the code events data from the controller and device events are sufficiently understood by a building or lift device manager, then the manager can use the code event data to remotely monitor and/or manage the lift devices.

It should be appreciated that lift devices including elevators are installed in a wide variety of buildings, and in many cases the owners of the buildings are not willing to pay for the installation of sensors or cameras for the purposes of remote lift device monitoring and management. One advantage of creating a mapping between the elevator manufacturer code events data and real-life device events is that this mapping or correlation can then be used to remotely monitor or manage lift devices/elevators even in cases where there are no sensors or cameras for that lift device. The remote manager can rely on the code events data from the controller to monitor and/or manage the lift device. For example, once the code events data correlating to accessing the top inspection station switch are understood, in the case of an elevator without remote sensors, the codes from the elevator controller can be used to remotely check whether maintenance is actually being performed on the elevator.

In cases where there are sensors or cameras on the lift device, the mapping or correlation from the controller code events data to real life device situations and computer vision can be used simultaneously to improve the confidence and robustness of the remote understanding of real-life events and thus the remote monitoring and management of lift devices (including elevators).

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the servers or computing devices or accessible or connectable thereto. Any application or module herein described may be implemented using computer readable/executable instructions that may be stored or otherwise held by such computer readable media.

It will be appreciated that different features of the example embodiments of the system and methods, as described herein, may be combined with each other in different ways. In other words, different modules, operations and components may be used together according to other example embodiments, although not specifically stated.

The steps or operations in the flow diagrams described herein are just for example. There may be many variations to these steps or operations according to the principles described herein. For instance, the steps may be performed in a differing order, or steps may be added, deleted, or modified.

The GUIs and screen shots described herein are just for example. There may be variations to the graphical and interactive elements according to the principles described herein. For example, such elements can be positioned in different places, or added, deleted, or modified.

Although the above has been described with reference to certain specific embodiments, various modifications thereof will be apparent to those skilled in the art without departing from the scope of the claims appended hereto.

What is claimed is:

1. A method for monitoring and managing lift devices, comprising:
transmitting first code events data from a first lift device controller for a first lift device to a computing device;
transmitting first sensor information from a first sensor on the first lift device to the computing device;
converting the first sensor information to information about first device events;
mapping correlations between the first device events with the first code events data, and storing these mappings; and
using these mappings to interpret second code events data from a second lift device controller for a second lift device as second device events, and using these second device events to monitor and control the second lift device.

2. The method of claim 1, where transmitting first code events data from a first lift device controller for a first lift device to a computing device includes transmitting timing information for the first code events data, and transmitting first sensor information from the first lift device to the computing device includes transmitting timing information for the first sensor information.

3. The method of claim 1, where the second lift device is the same as the first lift device.

4. The method of claim 1, where converting the first sensor information to information about first device events uses computer vision artificial intelligence.

5. The method of claim 1, further comprising:
transmitting second sensor information from a second sensor on the first lift device to the computing device, and
converting the first sensor information to information about first device events comprises converting the first sensor information and second sensor information to information about first device events.

6. The method of claim 1, where the first sensor is a camera.

7. The method of claim 1, further comprising updating the mappings by monitoring the first code events data and the first sensor information to see if the mappings from the first code event data correctly predict the device events, and if not correcting the mappings.

8. The method of claim 1 where using second device events to monitor and control the second lift device further comprises using second sensor information from the second lift device with the second device events to monitor and control the second lift device.

9. A system for monitoring and managing lift devices, comprising:
a first lift device controller for a first lift device configured to transmit first code events data from the first lift device controller to a computing device;
a first sensor for the first left device configured to transmit first sensor information from the first sensor to the computing device;
the computing device configured to convert the first sensor information to information about first device events;
the computing device configured to map correlations between the first device events with the first code events data, and storing these mappings; and
the computing device configured to use these mappings to interpret second code events data from a second lift device controller for a second lift device as second device events, and use these second device events to monitor and control the second lift device.

10. The system of claim 9, where the first lift device controller is further configured to transmit timing information for the first code events data, and first sensor is further configured to transmit timing information for the first sensor information.

11. The system of claim 9, where the second lift device is the same as the first lift device.

12. The system of claim 9, where the computing device is configured to convert the first sensor information to information about first device events using computer vision artificial intelligence.

13. The system of claim 9, further comprising:
a second sensor for the first left device configured to transmit second sensor information from the second sensor to the computing device; and
the computing device being configured to convert the first sensor information and the second sensor information to information about first device events.

14. The system of claim 9, where the computing device is further configured to update the mappings by monitoring the first code events data and the first sensor information to see if the mappings from the first code event data correctly predict the device events, and if not correcting the mappings.

15. The system of claim 9, where the computing device is configured to use second sensor information from the second lift device with the second device events to monitor and control the second lift device.
